(19) United States
(12) Patent Application Publication
(10) Pub. No.: US 2025/0208484 A1
(43) Pub. Date: Jun. 26, 2025

(54) Camera Module with Variable Lens Aperture with Soft Membrane

(71) Applicant: Apple Inc., Cupertino, CA (US)

(72) Inventors: Nicholas D Smyth, San Jose, CA (US); Samuel M Hyatt, San Jose, CA (US); Jason T Weaver, Morgan Hill, CA (US); Nitin Kumar Chennupati, Mountain View, CA (US); Rielly G Newton, San Jose, CA (US)

(73) Assignee: Apple Inc., Cupertino, CA (US)

(21) Appl. No.: 18/976,130

(22) Filed: Dec. 10, 2024

Related U.S. Application Data
(60) Provisional application No. 63/614,403, filed on Dec. 22, 2023.

(51) Int. Cl. G03B 9/06; G03B 5/00; H04N 23/55

(52) U.S. Cl. CPC G03B 9/06; G03B 5/00; H04N 23/55; G03B 2205/0069

(57) ABSTRACT

A camera includes an optical assembly having one or more lenses. The camera also includes an image sensor. The camera further includes a variable aperture assembly positioned along a light path extending from an object side of the one or more lenses of the optical assembly and to the image sensor. The variable aperture assembly includes a rotor, a stator, an actuator configured to rotate the rotor relative to the stator, and a flexible membrane attached to both the rotor and the stator. The flexible membrane is configured to vary a diameter of an aperture formed by the flexible membrane on the light path when the rotor rotates relative to the stator.

### PRIORITY CLAIM

This application claims benefit of priority to U.S. Provisional Application Ser. No. 63/614,403, entitled “Camera Module with Variable Lens Aperture with Soft Membrane,” filed Dec. 22, 2023, and which is hereby incorporated herein by reference in its entirety.

### BACKGROUND

### Technical Field

This disclosure relates generally to lens aperture for a camera module and, particularly to a variable lens aperture with a soft membrane.

### Description of the Related Art

The advent of small, mobile multipurpose devices such as smartphones and tablet or pad devices has resulted in a need for high-resolution, small form factor cameras for integration in the devices. Some cameras may incorporate optical image stabilization (OIS) mechanisms that may sense and react to external excitation/disturbance by adjusting location of the optical lens on the X and/or Y axis in an attempt to compensate for unwanted motion of the lens. Furthermore, some cameras may incorporate an autofocus (AF) mechanism whereby the object focal distance can be adjusted to focus an object plane in front of the camera at an image plane to be captured by the image sensor. Additionally, some cameras may incorporate a variable lens aperture for modulating the amount of light received by the lens(es) and/or the image sensor. In some such variable lens aperture mechanisms, the variable lens aperture is actuated using a plurality of overlapping blades that pivot to open and close the aperture.

### BRIEF DESCRIPTION OF THE DRAWINGS

FIGS. 1 and 2 illustrate components of an example camera having a variable aperture assembly that may, for example, change the diameter of an aperture/opening to change an amount of light that reaches lenses of an optical assembly and/or an image sensor in small form factor cameras, according to at least some embodiments. FIG. 1 shows an overhead view of the exterior of the camera. FIG. 2 shows a cross-sectional view of the camera.

FIG. 3 illustrates an exploded view of components of an example variable door assembly with a flexible membrane, according to at least some embodiments.

FIGS. 4a, 4b, and 4c illustrate overhead views of an example variable door assembly with a flexible membrane that may, for example, change the diameter of an aperture/opening to change an amount of light that reaches lenses of an optical assembly and/or an image sensor in small form factor cameras along with respective conceptual hyperboloids, according to at least some embodiments. FIG. 4a illustrates an overhead view of the variable aperture assembly when the flexible membrane is in a fully open position. FIG. 4b illustrates an overhead view of the variable aperture assembly when the flexible membrane is in a partially open position between the fully open position and a fully closed position. FIG. 4c illustrates an overhead view of the variable aperture assembly when the flexible membrane is in a fully closed position.

FIGS. 5a and 5b illustrate cross-sectional views of a camera having a variable aperture assembly with a flexible membrane that may, for example, change the diameter of an aperture/opening to change an amount of light that reaches lenses of an optical assembly and/or an image sensor in small form factor cameras, according to at least some embodiments.

FIG. 6 illustrates a cross-sectional perspective view of components of an example variable door assembly with a flexible membrane, according to at least some embodiments.

FIG. 7a illustrates an example method of assembling a variable aperture assembly with a flexible membrane along with representational diagrams, according to at least some embodiments.

FIG. 7b illustrates an example flexible membrane application tool for assembling a variable aperture assembly, according to at least some embodiments.

FIG. 8 illustrates an overhead and perspective view of an example set of magnets and coil array for actuating a variable aperture assembly with a flexible membrane, according to at least some embodiments.

FIG. 9 illustrates an overhead and perspective view of another example set of magnets and coil array for actuating a variable aperture assembly with a flexible membrane, according to at least some embodiments.

FIG. 10 illustrates an overhead and cross-sectional view of an example set of magnets and coils for actuating a variable aperture assembly with a flexible membrane, according to at least some embodiments.

FIG. 11 illustrates a perspective view of another example set of magnets and coils for actuating a variable aperture assembly with a flexible membrane, according to at least some embodiments.

FIG. 12 illustrates a perspective view of yet another example set of magnets and coils for actuating a variable aperture assembly with a flexible membrane, according to at least some embodiments.

FIG. 13 illustrates a perspective view of a variable aperture assembly with multiple flexible membranes that may, for example, change the diameter of an aperture/opening to change an amount of light that reaches lenses of an optical assembly and/or an image sensor in small form factor cameras, according to at least some embodiments.

FIGS. 14 and 15 illustrate overhead views of a variable aperture assembly with multiple flexible membranes that may, for example, change the diameter of an aperture/opening to change an amount of light that reaches lenses of an optical assembly and/or an image sensor in small form factor cameras, according to at least some embodiments. FIG. 14 illustrates an overhead view of the variable aperture assembly when the multiple flexible membranes are in an open position. FIG. 15 illustrates an overhead view of the variable aperture assembly when the multiple flexible membranes are in a closed position.

FIG. 16 illustrates a schematic representation of an example device that may include a camera, in accordance with some embodiments.

FIG. 17 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to a variable aperture assembly (e.g., a variable door assembly), for a camera module (e.g., a small form factor camera module) that may be positioned over an aperture. The aperture may allow/permit light from an external environment (e.g., external to the camera module) to pass therethrough to one or more lenses of the camera module and/or an image sensor of the camera module. The variable aperture assembly may change or vary (e.g., modulate) a diameter of the aperture to change an amount of light from the external environment that reaches the lenses and/or the image sensor of the camera module. Conventional variable door assemblies generally include overlapping mechanical blades that are positioned such that they produce an adjustable aperture mounted above a lens and/or an image sensor of a camera module. When actuated, the blades move towards an open or towards a closed position to adjust the aperture's diameter to dynamically change the focal length of the camera module giving more control over the depth of field.

However, some variable aperture assemblies with overlapping mechanical blades have several drawbacks. For example, the variable aperture assembly with overlapping mechanical blades have many moving parts creating a high risk of failure and produce a high amount of weight on the camera module. Also, the overlapping mechanical blades occupy a significant amount of x, y, and z space in the camera module, for example, when the blades are partially or fully retracted. As a result, small form factor cameras are limited with regards to how small in size those camera can be and/or the aperture providing light from the external environment and to the lenses and/or image sensor of the camera module may be limited in size. Further, cosmetically, the overlapping mechanical blades produce a hexagonal opening when in the fully actuated position and therefore produce a lack of aesthetic symmetry when viewing the camera module. In addition, because the overlapping mechanical blades produce a hexagonal opening when in the fully actuated position, the overlapping mechanical blades are not able to fully close the aperture.

As described herein, a variable aperture assembly, for a camera module (e.g., a small form factor camera module) may include one or more flexible membranes (e.g., a hyper-elastic, soft, thin, stretchy material) instead of overlapping mechanical blades. For example, a variable aperture assembly for a camera module may be positioned over an aperture for allowing/permitting light to pass therethrough to one or more lenses of the camera module and/or an image sensor of the camera module. The variable aperture assembly may change or vary (e.g., modulate) a diameter of the aperture to change an amount of light that reaches the lenses and/or the image sensor of the camera module. The variable aperture assembly may include a rotor and a stator with an opening therethrough. The opening may be positioned along a light path the extends from an object-side (e.g., an exterior environment of the camera) of the one or more lenses of an optical assembly of the camera and to the image sensor of the camera. In some aspects, the light path may be aligned with an optical axis of a camera module. The variable aperture assembly may also include one or more flexible membranes. Each of the flexible membranes may be attached (e.g., fixedly attached) to both the rotor and the stator. When the rotor rotates relative to the stator creating a torsion load, the flexible membrane(s) stretch and create a hyperboloid shape and extend into the opening of the rotor and stator reducing the diameter of the opening and the aperture and thus reducing the amount of light that pass along the light path from the external environment, through the aperture, and to the lenses and/or the image sensor the camera module. In some aspects, the flexible membrane is configured to vary a diameter of an aperture formed by the flexible membrane on the light path when the rotor rotates relative to the stator.

Using the flexible membrane(s) rather than the overlapping mechanical blades mitigates problems with the overlapping mechanical blades. For example, the variable aperture assemblies using flexible membrane(s) may be made with fewer moving parts than those variable door assemblies with overlapping mechanical blades thereby reducing the risk of failure and producing a lower amount of weight on the camera module. Also, compared to variable door assemblies with overlapping mechanical blades, the variable aperture assemblies using flexible membrane(s) occupy much less space in the camera in the x, y, and z directions, for example, when the flexible membrane(s) are partially or fully retracted. As a result, small form factor cameras that use a variable aperture assembly using the flexible membrane(s) instead of overlapping mechanical blades can be smaller in size and/or can have larger apertures for providing light from the external environment (e.g., an object side of the optical assembly and/or the one or more lenses of the optical assembly) and to the lenses and/or image sensor of the camera module. Further, compared to variable door assemblies with the overlapping mechanical blades that produce a hexagonal opening when in the closed position, variable door assemblies with flexible membrane(s) may move towards a closed position while maintaining a circular opening therethrough and therefore attain aesthetic symmetry when viewing the camera module. In addition, compared to the variable aperture assemblies with overlapping mechanical blades that produce a hexagonal opening when in the fully closed position, the variable aperture assemblies with the flexible membrane(s) may be able to fully close the aperture and prevent light from reaching the lenses and/or image sensor of the camera module from the external environment and through the aperture.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

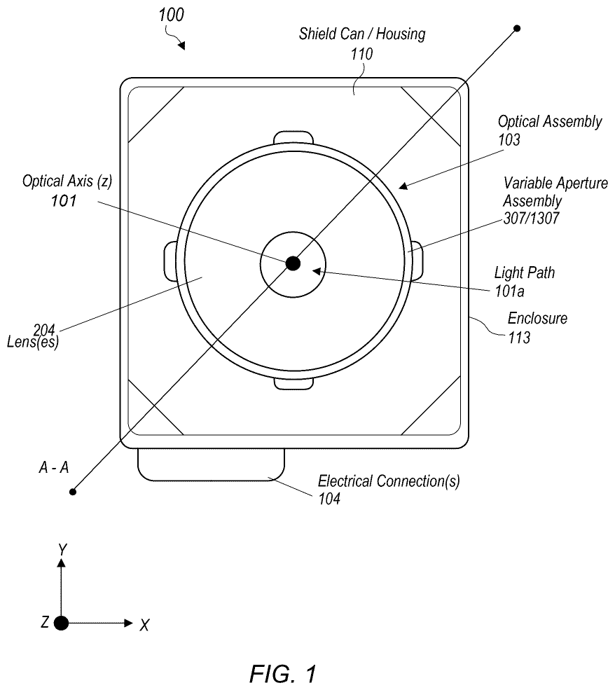

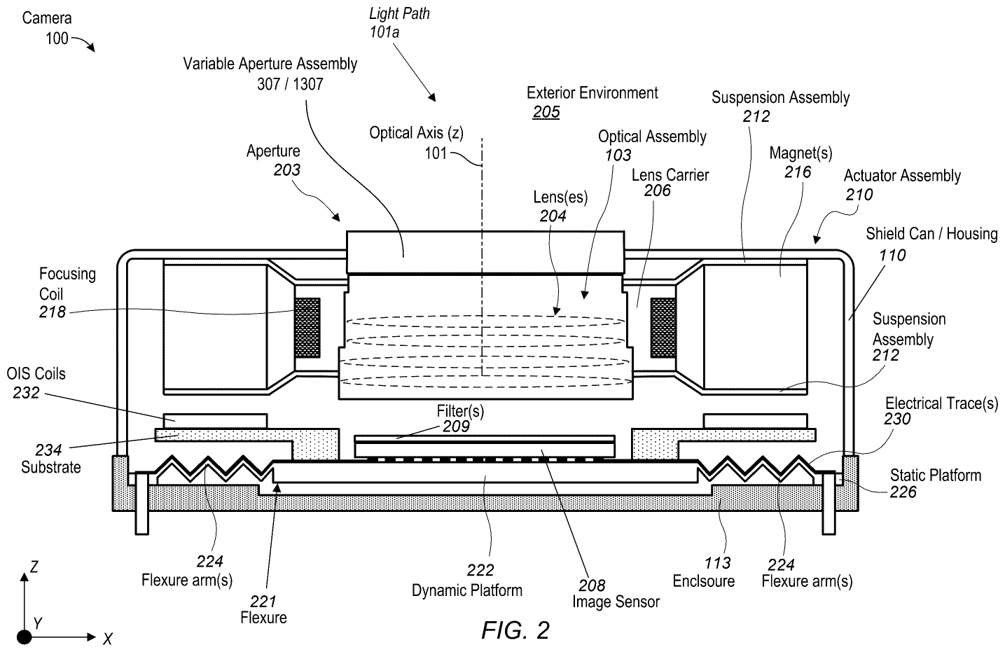

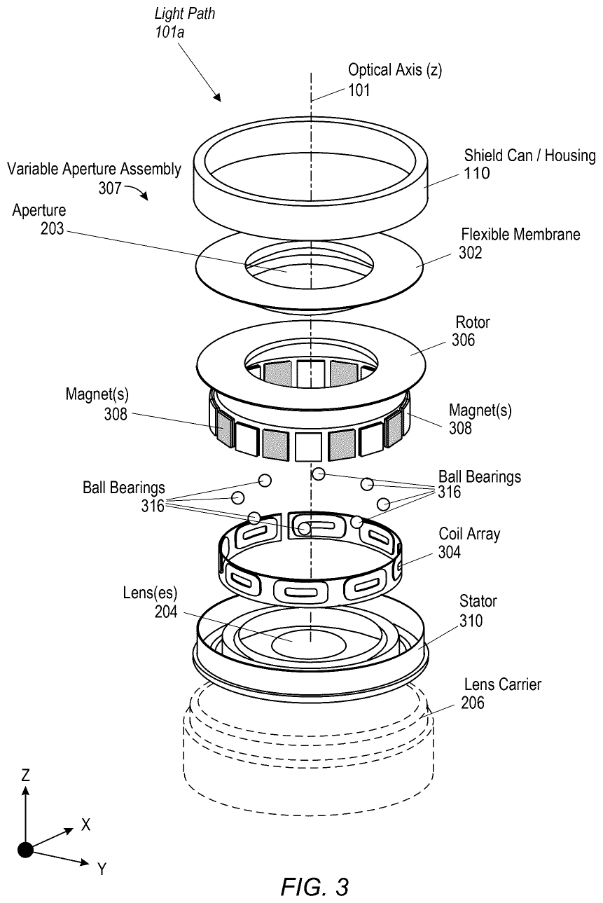

FIGS. 1 and 2 illustrate components of an example camera having a variable aperture assembly that may, for example, change or vary the diameter of an aperture/opening to change an amount of light that reaches lenses of an optical assembly and/or an image sensor in small form factor cameras, according to at least some embodiments. FIG. 1 shows an overhead view of the exterior of the camera. FIG. 2 shows a cross-sectional view of the camera. The camera 100 of FIGS. 1 and 2 may include one or more same or similar features as the features described with respect to or illustrated in FIGS. 3, 4a, 4b, 4c, 5a, 5b, 6, 7a, 7b, 8, 9, 10, 11, 12, 13, 14, 15, 16, and 17. The example X-Y-Z coordinate system shown in FIGS. 1 and 2 may be used to discuss aspects of components and/or systems, and may apply to embodiments described throughout this disclosure.

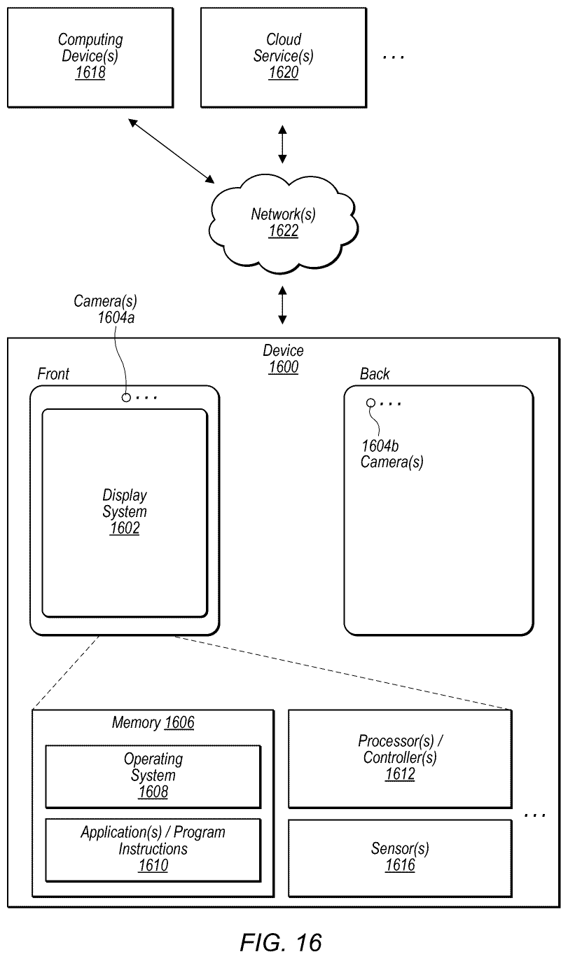

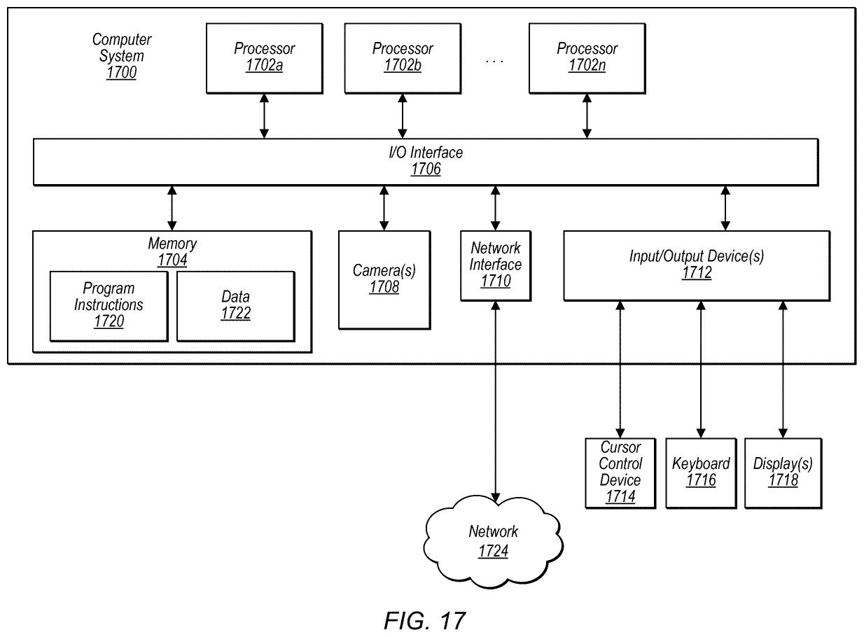

In various embodiments, the camera 100 may include an optical assembly 103 having one or more lenses 204. In some aspects, the one or more lenses 204 may be positioned along a light path 101a. The light path 101a may extend from an environment external to the camera 100, through the aperture 203, through the one or more lenses 204, and to the image sensor 208. In some aspects, the light path 101a may extend from an object side of the optical assembly 103 and to the image sensor 208. In some aspects, light path 101a extends along an optical axis 101 defined by the one or more lenses 204. The camera 100 may also include a shield can or housing 110, an enclosure or base 113, and electrical connection(s) 104. The shield can 110 may form an outer wall of a top portion (and in some cases side portions) of the camera 100 and form one or more camera shoulders. The enclosure 113 may form an outer wall of a bottom portion (and in some cases side portion(s)) of the camera 100. The electrical connection(s) 104 may extend from the enclosure 113 (and/or the shield can 110) and may electrically connect the camera 100 to an external device. For example, the camera 100 may be the same or similar camera as the camera 1604b illustrated in FIG. 16 or the camera 1708 illustrated in FIG. 17. As such, the electrical connection(s) 104 may extend from the enclosure 113 and may electrically connected the camera 100 to the device 1600 illustrated in FIG. 16 or the computer system 1700 illustrated in FIG. 17, respectively. In some aspects, the camera 100 may include autofocus (AF) cameras (e.g., movement of the image sensor 208 (e.g., illustrated in FIG. 2) and/or the optical assembly 103 in the z-direction along the optical axis) and/or may include optical image stabilization (OIS) (e.g., movement of the image sensor 208 and/or the optical assembly 103 in one or more directions orthogonal to (x-direction, y-direction) or not parallel to the optical axis 101) of the image sensor 208 and/or the optical assembly 103. The variable aperture assembly 307/1307 may be positioned along the light path 101a. For example, the variable aperture assembly 307/1307 may be aligned with the optical axis 101 and/or the lenses 204 of the optical assembly 103 over an aperture/opening 203. The variable aperture assembly 307/1307 may be configured to change or vary (e.g., modulate) the diameter of the aperture 203 to change an amount of light that pass through the light path 101a to reach the lenses 204 of the optical assembly 103 and/or the image sensor 208 in small form factor cameras 100, as described further herein.

In various embodiments, the camera 100 may also include a flexure 221, an actuator assembly 210, a substrate 234 (e.g., an OIS FPC, printed circuit board, and/or the like), the image sensor 208, and filter(s) 209 positioned between the optical assembly 103 and the image sensor 208. The flexure 221 may include a dynamic platform 222, a static platform 226, and a plurality of flexure arms 224. The flexure 221 may be connected to an interior surface of the shield can 110 and/or the enclosure 113 via a static platform 226. The flexure 221 may also retain the substrate 234, the image sensor 208, and the filter(s) 209 via the dynamic platform 222. The plurality of flexure arms 224 may provide a flexible mechanical coupling between the static platform 226 and the dynamic platform 222. For example, the flexure arms 224 may allow the dynamic platform 221 to move in one or more directions orthogonal to the optical axis 101 relative to the static platform 226 (e.g., and a remainder of the camera 100) using components of the actuator assembly 210. For example, the actuator assembly 210 may include the magnet(s) 216 fixedly attached to an interior surface of the shield can 110 (e.g., via the suspension assembly 212, via direct attachment to the interior surface of the shield can 110) and the OIS coils 232 mounted on the substrate 234. Pairs of magnets 216 and OIS coils 232 may together be a voice coil motor (VCM). A magnetic field from respective magnets 216 may interact with current flowing through the respective OIS coils 232 creating Lorentz forces to move the dynamic platform 222 including the substrate 234 and the image sensor 208 in one or more directions orthogonal (e.g., x-direction, y-direction) to the optical axis 101. In some aspects, the flexure arms 224 may include electrical traces 230 for communicating electrical power and electrical signals between the dynamic platform 222 (e.g., one or more electronic components mounted on the substrate 234, the image sensor 208 mounted on the substrate 234, one or more electronic components mounted to the dynamic platform 222, or the like) and the static platform 226. The static platform 226 may be in electrical communication with one or more other components of the camera 100, via an electrical connection, for performing one or more camera operations.

In some non-limiting examples, the image sensor 208 may be attached to or otherwise integrated into the substrate 234, such that the image sensor 208 is connected to the OIS frame or flexure 221 via the substrate 234. For example, the dynamic platform 222 may retain the substrate 234 for mounting one or more electronic components and/or the image sensor 208. In some aspects, the substrate 234 may include an opening with a cross-section sized to permit light to pass therethrough while also receiving or retaining the filter(s) 209 and the image sensor 208. The substrate 234 may retain the filter(s) 209 and the image sensor 208 around a perimeter of the opening. In some aspects, the image sensor 208 may be retained on the top surface of the substrate 234 while the filter(s) 209 may be positioned between the optical assembly 103 and the image sensor 208. These configuration may allow the substrate 234 to retain the image sensor 208 (and in some cases the filter(s) 209) while also allowing light to pass from the lens(es) 204 of the optics assembly 103, through the filter(s) 209, and be received by the image sensor 208 for image capturing. In other embodiments, the substrate 234 and the image sensor 208 may be separately attached to the OIS frame or flexure 220. For instance, a first set of one or more electrical traces 216 may be routed between the substrate 234 and the OIS frame or flexure 221. A second, different set of one or more electrical traces 216 may be routed between the image sensor 208 and the OIS frame or flexure 221.

In some aspects, the camera 100 may include the optical assembly 103 including the one or more lenses 204, a lens carrier 206, and a suspension assembly 212. The actuator assembly 210 may move the optical assembly 103 along the optical axis 101 to provide autofocus. For example, the actuator assembly 210 may include the magnets 216 and the focusing coils 218 attached to the lens carrier 206. The respective magnets 216 and the respective focusing coils 218 may together be a voice coil motor (VCM). A magnetic field from the magnets 216 may interact with current flowing through the focusing coils 218 creating Lorentz forces to move the optical assembly 103 including the lenses 204 along the optical axis 101 (e.g., in the z-direction) for autofocus. The suspension assembly 212 may be attached to both an interior surface of the shield can 110 and the lens carrier 206 and provide damping of movement of the optical assembly 103 in the z-direction along the optical axis 101. The suspension assembly 212 may retain the optics assembly 102 within a z-range of motion relative to the shield can 110 and/or the image sensor 208 during activation of the actuator assembly 210 for autofocus.

The camera 100 may also include an aperture 203 formed through the shield can 110 and centered on the optical axis 101 for allowing light to pass from the exterior environment 205 (e.g., an object side of the optical assembly 103) and through the shield can 110 and to the lenses 204 of the optical assembly 103 and/or the image sensor 208. A variable aperture assembly 307/1307 may be positioned within and/or over the aperture 203. As described herein, the variable aperture assembly 307/1307 may change or modulate a diameter of the aperture 203 to change an amount of light that passes therethrough and reaches the lenses 204 and/or the image sensor 208 of the camera module 100.

In some aspects, a variable aperture assembly may include a variable aperture assembly cover, a plurality of blades (e.g., overlapping mechanical blades as described herein), a rotor including magnets, a stator including coils and ball bearings, and a circuit board. The variable aperture assembly cover, the plurality of blades, the rotor, the stator, and the circuit board may be centered around the optical axis. The variable aperture assembly cover may form a portion of an outer surface of the variable aperture assembly and may be exposed to the exterior environment. The plurality of blades may be configured to attach to the rotor and move to increase or decrease the diameter of the aperture (e.g., the aperture 203 of FIG. 2) as described herein. Respective blades may be attached to the rotor at respective pivot points for enabling the respective blades to pivot relative to the rotor when the rotor moves (e.g., rotates) relative to the stator. For example, respective blade pivot points may align vertically with respective rotor pivot points so that the respective blades pivot about the respective aligned blade pivot points and rotor pivot points when the rotor moves (e.g., rotates) relative to the stator. Respective protrusions extending vertically from the stator may be received by respective slots of respective blades. When the rotor moves (e.g., rotates) relative to the stator, the respective protrusions slide within the respective slots to move the blades through a plurality of different positions between and including a fully open position and the fully actuated position.

The rotor may also rest on the ball bearing so that when the coils receive an electric current, via the circuit board, and interact with the magnetic fields from the magnets creating Lorentz force, the rotor rotates around the optical axis and relative to the stator. As the rotor rotates around the optical axis and relative to the stator, each of the plurality of blades attached to the rotor pivot changing the diameter of the aperture and changing or modulating the amount of light that pass through the aperture. For example, as described herein, when the rotor rotates in a first direction (e.g., a counter-clockwise direction) relative to the stator, the plurality of blades may pivot on the rotor and increase the diameter of the aperture. As another example, when the rotor rotates in a second direction, opposite the first direction, (e.g., a clockwise direction) relative to the stator, the plurality of blades may pivot on the rotor and decrease the diameter of the aperture.

As mentioned herein, the variable aperture assembly with plurality of blades (e.g., overlapping mechanical blades) may have many moving parts and create a high risk of failure and produce a high amount of weight on the camera. Also, the plurality of blades may occupy a significant amount of x, y, and z space in the camera, for example, when the blades are partially or fully retracted. As a result, small form factor camera may be limited with regards to how small in size those cameras can be and/or may be limited with regards to how large the aperture providing light from the external environment and to the lenses and/or image sensor of the camera module may be.

In some aspects, the variable aperture assembly may be in a fully open position. In the fully open position, the variable aperture assembly produces an aperture having a first diameter for allowing/permitting light to pass therethrough. In some aspects, the variable aperture assembly may be in a partially open position. For example, the rotor may have rotated relative to the stator over the ball bearings due to the Lorentz forces from the interaction between the coils and the magnets causing the plurality of blades to pivot and decrease the diameter of the aperture. The plurality of blades may pivot and decrease the diameter of the aperture from the first diameter to a second diameter. As described herein, due to shape of each of the plurality of blades, the second diameter may have a hexagonal shape. In some aspects, the variable aperture assembly may be in a fully actuated position. For example, the rotor may have rotated relative to the stator over the ball bearings due to the Lorentz forces from the interaction between the coils and the magnets causing the plurality of blades to pivot and decrease the diameter of the aperture. The plurality of blades may pivot and decrease the diameter of the aperture from the second diameter to the third diameter. As described herein, due to shape of each of the plurality of blades, the third diameter may have also have a hexagonal shape. It should be noted that when the variable aperture assembly is in the fully actuated state, the variable aperture assembly is unable to fully close the aperture because of the blades (e.g., the overlapping mechanical blades).

As mentioned herein, with the variable aperture assembly and its blades may produce a cosmetically displeasing appearance. For example, the blades may produce a hexagonal opening when in the fully actuated position and therefore produce a lack of aesthetic symmetry when viewing the camera module. In addition, because the blades produce a hexagonal opening when in the fully actuated position, the blades are not able to fully close the aperture.

FIG. 3 illustrate an exploded view of components of an example variable door assembly 307 with a flexible membrane 302, according to at least some embodiments. The variable aperture assembly 307 of FIG. 3 may include one or more same or similar features as the features described with respect to or illustrated in FIGS. 1, 2, 4a, 4b, 4c, 5a, 5b, 6, 7a, 7b, 8, 9, 10, 11, 12, 13, 14, 15, 16, and 17. The example X-Y-Z coordinate system shown in FIG. 3 may be used to discuss aspects of components and/or systems, and may apply to embodiments described throughout this disclosure.

As shown in FIG. 3, the variable aperture assembly 307 includes the flexible membrane 302, a rotor 306, a plurality of magnets 308, ball bearings 316, a coil array 304 including a plurality of coils, and a stator 310. The variable aperture assembly 307 may be positioned between the shield can 110 and the lens carrier 206 of the camera 100. As described herein, the flexible membrane 302 may be made of a hyper-elastic, soft, thin, stretchy material. In some aspects, the flexible membrane 302 may include an elastomer, stretchy fabric, woven materials, or the like. For example, the flexible membrane 302 may be formed of one or more of silicone, a fluorocarbon, an aflas, a fluorosilicone, a polyacrylate, an HNBR, an ethylene propylene, a nitrile, and/or a neoprene. In some aspects, the flexible membrane 302 may include one or more characteristics such as a thickness between about 50 μm and about 100 μm, a shore hardness of Shore A, 100% Young's Modulus of less than 30 MPa, an elongation greater than 500%, a fatigue strain amplitude greater than about 100%, a frequency greater than 1Hz, a number or quantity of life cycles greater than about 10,000, a non-operation temperature range from about −40 C to about 100 C, an operation temperature range from about 0 C to about 65 C, a color pitch black, and/or a light transmissivity of very low. In some aspects, the flexible membrane 302 may be optically opaque so as to prevent light from passing therethrough, for example, when the variable aperture assembly 307 is not in the fully open position (and is in a partially open position or a fully closed position). In some aspects, the flexible membrane 302 may maintain a same or very similar amount of optical opacity as the flexible membrane 302 is stretched.

In some aspects, if the flexible membrane 302 is too thin (e.g., less than about 30 μm), the flexible membrane 302 may have enough elasticity to adequately reduce the diameter of the aperture 203 when the variable aperture assembly 307 is actuated, but may lack enough opacity (e.g., light opacity) to prevent light from passing therethrough, for example, before the flexible membrane 302 is stretched and/or when the flexible membrane 302 is stretch. Conversely, if the flexible membrane 302 is too thick (e.g., greater than about 120 μm), the flexible membrane 302 may have enough opacity (e.g., light opacity) to prevent light from passing therethrough, for example, before the flexible membrane 302 is stretched and/or when the flexible membrane 302 is stretch, but may lack enough elasticity to adequately reduce the diameter of the aperture 203 when the variable aperture assembly 307 is actuated. Thus, a flexible membrane 302 within a thickness range (e.g., less than about 110 μm and greater than about 40 μm) may have a sufficient amount of opacity to prevent or minimize an amount of light from passing therethrough, for example, before the flexible membrane 302 is stretched and/or when the flexible membrane 302 is stretch while also having enough elasticity to adequately reduce the diameter of the aperture 203 when the variable aperture assembly 307 is actuated.

In some aspects, the flexible membrane 302 may have a thickness (e.g., no more than about 100 μm and no less than about 30 μm) sufficient enough to sufficiently prevent light from passing therethrough before the flexible membrane 302 is actuated and stretched while being thin enough to have enough elasticity to adequately reduce the diameter of the aperture 203 when the variable aperture assembly 307 is actuated. Additionally, the flexible membrane 302, due to its thinness, may produce a plurality of pleats or folds when the flexible membrane 302 is actuated towards the closed position. For example, the flexible membrane 302 may be attached to both the rotor 306 and the stator 310. When the rotor 306 rotates about the optical axis 101 and relative to the stator 310, the flexible membrane 306 due to its thinness folds over itself as it extends into the aperture 203 in a closing direction. The pleats or folds created as the flexible membrane 302 extends into the aperture 203 maintains the opaqueness of the flexible membrane 302. Thus, for a particular thickness range (e.g., no more than about 100 μm and no less than about 30 μm), the flexible membrane 302 may be thin enough to have enough elasticity to adequately reduce the diameter of the aperture 203 when the variable aperture assembly 307 is actuated while also being thick enough to sufficiently prevent light from passing therethrough before the flexible membrane 302 is actuated and stretched even if the flexible membrane 302 is not thick enough to sufficiently prevent light from passing therethrough when the flexible membrane 302 is independently stretched (e.g., stretched on its own when it is not stretched with the relative rotor 306 and stator 310 movement). Due to overlapping of the flexible membrane 302 forming the pleats of folds that are produced when the flexible membrane 302 is actuated, the flexible membrane 302 may sufficiently prevent light from passing therethrough when the flexible membrane 302 is actuated and stretched even though it is not thick enough to sufficiently prevent light from passing therethrough when the flexible membrane 302 is independently stretched.

It should be understood that the thicker the flexible membrane 302 is, the less folds or pleats are produced when the flexible membrane 302 extends into the aperture 203. Conversely, it should be understood that the thinner the flexible membrane 302 is, the more folds or pleats are produced when the flexible membrane 302 extends into the aperture 203. The more folds or pleats that are produced as the flexible membrane 302 extends into the aperture, the more effective the flexible membrane 302 may be at preventing light from passing therethrough. Thus, a thin flexible membrane 302 may generate enough folds when extending into the aperture 203 to maintain an opacity to prevent light from passing therethrough while counteracting decreased opacity of the flexible membrane 302 as it stretches. In some aspects, when the flexible membrane 302 is above a threshold thickness (e.g., greater than about 175 μm), the flexible membrane 302, due to the thickness of the pleats or folds produced during actuation, may begin to lose its ability to close in a circular configuration and instead may begin to close in an octagonal or a hexagonal configuration. For example, as a selected thickness of the flexible membrane 302 increases, the number of folds or pleats become larger and decrease in quantity when the flexible membrane 302 is actuated and stretched. With larger and fewer pleats, the opening in the middle of the flexible membrane 302 becomes less circular and more flat sided producing, for example, an octagonal opening or a hexagonal opening, rather than a circular opening. Conversely, with smaller and more pleats, the opening in the middle of the flexible membrane 302 becomes more circular and less flat sided producing, for example, a circular opening rather than an octagonal opening or a hexagonal opening.

Continuing with FIG. 3, the variable aperture assembly 307 may include magnets 308 and a coil array 304 including a plurality of coils. The magnets 308 may be fixedly attached to the rotor 306 and the coil array 304 having the plurality of coils may be fixedly attached to the stator 310. In some aspects, the positions of the magnets 308 and the coils of the coil array 304 may be reversed with respect to the rotor 306 and the stator 310. The flexible membrane 302 may be attached to both the rotor 306 and the stator 310. Upon an actuating force, the rotor 306 may rotate about the optical axis 101 and over the stator 310 via the ball bearings 316. For example, the magnets 308 fixedly attached to the rotor 306 may be positioned adjacent the coils of the coils array 304 fixedly attached to the stator 310. When the coils of the coil array 304 receive an electrical current, the coils on the stator 310 interact with the magnetic field produced by the adjacent magnets 308 on the rotor 306 generating Lorentz forces causing rotation of the rotor 306 relative to the stator 310. As the rotor 306 rotates in a first direction relative to the stator 310, the flexible membrane 302 extends increasingly further into the aperture 203 via a hyperboloid effect reducing the diameter of the aperture 203 and closing the aperture 203. As the rotor 306 rotates in a second direction, opposite the first direction and relative to the stator 310, the flexible membrane 302 retracts away from the optical axis 101 increasing the size of the aperture 203. It should be understood that while the variable aperture assembly 307 (as well as the variable aperture assembly 1307) may utilize an actuator including magnets 308 and a coil array 304 including a plurality of coils, the variable aperture assembly 307 (as well as the variable aperture assembly 1307) may additionally, or alternatively, utilize actuator including piezoelectric actuators, shape-memory alloy (SMA) actuators, or the like.

Using the variable aperture assembly 307 with the flexible membrane 302 rather than the variable aperture assembly 107 with the plurality of blades 304, illustrated in FIG. 3, mitigates problems with the plurality of blades 304. For example, the variable aperture assembly 307 with the flexible membrane 302 may be made with fewer moving parts than the variable aperture assembly 107 with the plurality of blades 304 reducing the risk of failure and producing a lower amount of weight on the camera module. Also, compared to the variable aperture assembly 107 with the plurality of blades 304, the variable aperture assembly 307 with the flexible membrane 302 may occupy much less space in the camera in the x, y, and z directions, for example, when the flexible membrane 302 is partially or fully retracted. As a result, small form factor cameras that use the variable aperture assembly 307 with the flexible membrane 302 instead of the variable aperture assembly 107 with the plurality of blades 304 can be smaller in size and/or can have larger apertures for providing light from the external environment and to the lenses and/or image sensor of the camera module.

Further, compared to variable door assemblies with the overlapping mechanical blades that produce a hexagonal opening when in the closed position, variable door assemblies with flexible membrane(s) may move towards a closed position while maintaining a circular opening therethrough and therefore attain aesthetic symmetry when viewing the camera module. In addition, compared to the variable aperture assemblies with overlapping mechanical blades that produce a hexagonal opening when in the fully closed position, the variable aperture assemblies with flexible membrane(s) are able to fully close the aperture and prevent light from reaching the lenses and/or image sensor of the camera module from the external environment and through the aperture.

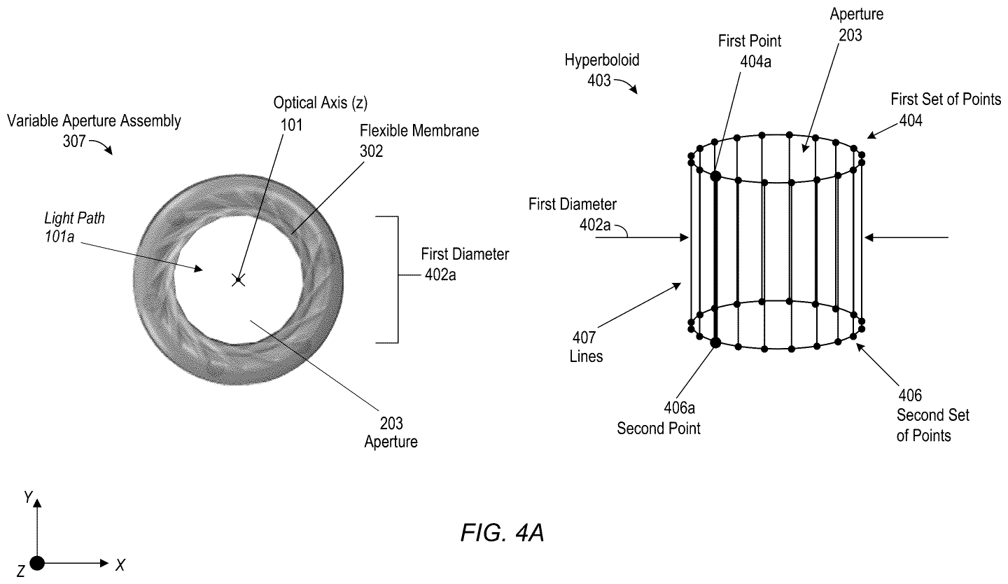

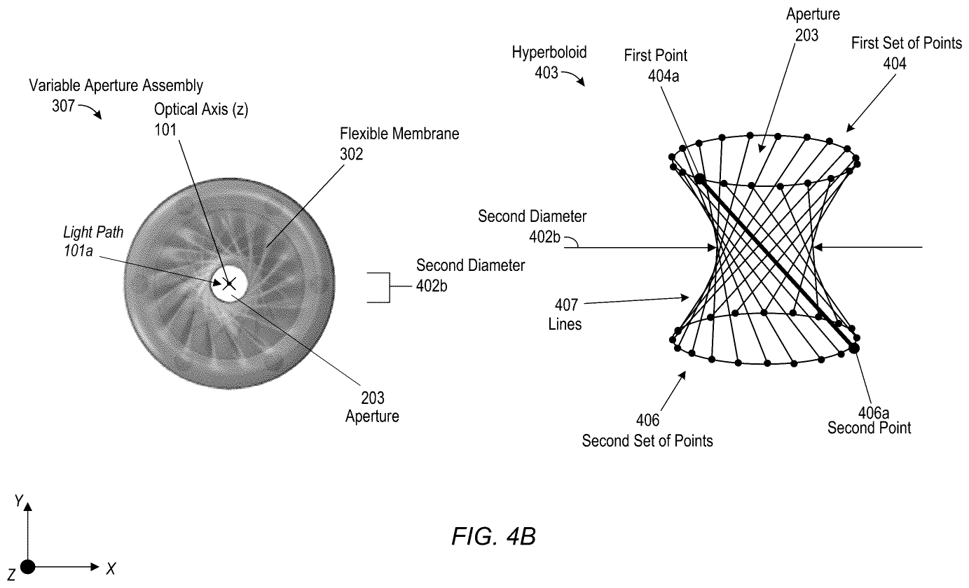

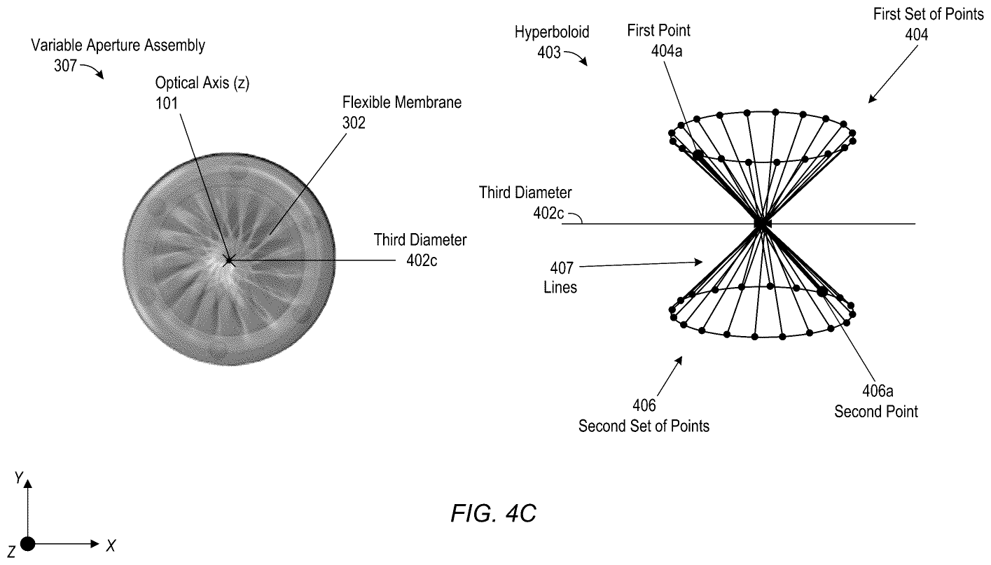

FIGS. 4a, 4b, and 4c illustrate overhead views of an example variable door assembly 307 with a flexible membrane 302 that may, for example, change the diameter of an aperture/opening to change an amount of light that reaches lenses of an optical assembly and/or an image sensor in small form factor cameras along with respective conceptual hyperboloids, according to at least some embodiments. FIG. 4a illustrates an overhead view of the variable aperture assembly when the flexible membrane is in a fully open position. FIG. 4b illustrates an overhead view of the variable aperture assembly when the flexible membrane is in a partially open position between the fully open position and a fully closed position. FIG. 4c illustrates an overhead view of the variable aperture assembly when the flexible membrane is in a fully closed position. The variable aperture assembly 307 of FIGS. 4a, 4b, and 4c may include one or more same or similar features as the features described with respect to or illustrated in FIGS. 1, 2, 3, 5a, 5b, 6, 7a, 7b, 8, 9, 10, 11, 12, 13, 14, 15, 16, and 17. The example X-Y-Z coordinate system shown in FIGS. 4a, 4b, and 4c may be used to discuss aspects of components and/or systems, and may apply to embodiments described throughout this disclosure.

As shown in FIG. 4a, the variable aperture assembly 307 may be in a fully open position. In the fully open position, the flexible membrane 302 of the variable aperture assembly 307 produces an aperture 203 having a first diameter 402a, a largest or maximum diameter, for allowing/permitting light to pass therethrough. The variable aperture assembly 307 may have the characteristics of the hyperboloid 403. The hyperboloid 403 has a first set of points 404 including a first point 404a, a second set of points 406 including a second point 406a and the first diameter 402a. The first set of points 404 may represent the stator 310 of the variable aperture assembly 307 and the second set of points 406 may represent the rotor 306 of the variable aperture assembly 307. The lines 407 attached to the first set of points 404 and the second set of points 406 may represent the flexible membrane 302 attached to the rotor 306 and the stator 310. As shown in FIG. 4a, the first point 404a of the first set of points 404 is vertically aligned with the second point 406a of the second set of points 406 such that no torsion is produced on the lines 407 representing a position of the flexible membrane 302 in a fully retracted state or a fully open position of the aperture 203. Like the flexible membrane 302 in the fully open position, the lines 407 together form the largest diameter, the first diameter 402a.

As shown in FIG. 4b, the variable aperture assembly 307 may be in a partially closed (or a partially open) position. In the partially closed position, the flexible membrane 302 has extending into some space previously occupied by the aperture 203 decreasing the diameter of the aperture 203 from the first diameter 402a (the largest diameter) to a second diameter 402b (a smaller diameter) for allowing/permitting some light to pass therethrough. For example, the rotor 306 may have rotated a distance about the optical axis 101 and relative to the stator 310, and due to the hyperboloid effect, the flexible membrane 302 may have extended a distance into the aperture 203 reducing the diameter of the aperture 203 from the first diameter 402a to the second diameter 402b. Similarly, with respect to the hyperboloid 403, the second set of points 406 including second point 406a of the hyperboloid 403 and representing the rotor 306 may have rotated relative to the first set of points 404 including the first point 404a representing the stator 310. Because of the rotation of the second set of points 406 including the second point 406a (representing the rotor 306) relative to the first set of point 404 including the first point 404a (representing the stator 310), the lines 407 attached to the first set of points 404 and the second set of points 406 (representing the flexible membrane 302 attached to the rotor 306 and the stator 310) stretch and extend at least partially towards the center due to the hyperboloid effect reducing the diameter of the aperture 203 from the first diameter 402a to the second diameter 402b.

As shown in FIG. 4c, the variable aperture assembly 307 may be in a fully actuated or fully closed position. In the fully closed position, the flexible membrane 302 has extended into the entire space previously occupied by the aperture 203 decreasing the diameter of the aperture 203 from the second diameter 402b until the aperture 203 is no longer there and has third diameter 402c, a zero diameter, preventing light to pass therethrough. For example, the rotor 306 may have rotated another distance about the optical axis 101 and relative to the stator 310, and due to the hyperboloid effect, the flexible membrane 302 may have extended completely into the aperture 203 closing the aperture 203 so that the third diameter 402c is zero diameter. Similarly, with respect to the hyperboloid 403, the second set of points 406 including second point 406a of the hyperboloid 403 and representing the rotor 306 may have rotated further relative to the first set of points 404 including the first point 404a representing the stator 310. Because of the further rotation of the second set of points 406 including the second point 406a (representing the rotor 306) relative to the first set of point 404 including the first point 404a (representing the stator 310), the lines 407 attached to the first set of points 404 and the second set of points 406 (representing the flexible membrane 302 attached to the rotor 306 and the stator 310) stretch and extend towards the center due to the hyperboloid effect completely closing the aperture 203 from the second diameter 402b to the third diameter 402c, the zero diameter.

Using the variable aperture assembly 307 with the flexible membrane 302 rather than the variable aperture assembly with the plurality of blades, mitigates problems with the plurality of blades. For example, compared to the variable aperture assembly with the plurality of blades that produce a hexagonal opening when in the closed position, the variable aperture assembly 307 with the flexible membrane 302 may move towards a closed position while maintaining a circular opening therethrough and therefore attain aesthetic symmetry when viewing the camera module. In addition, compared to the variable aperture assembly with plurality of blades that produce a hexagonal opening when in the fully closed position, the variable aperture assembly 307 with the flexible membrane 302 is able to fully close the aperture 203 and prevent light from reaching the lenses and/or image sensor of the camera module from the external environment and through the aperture 203.

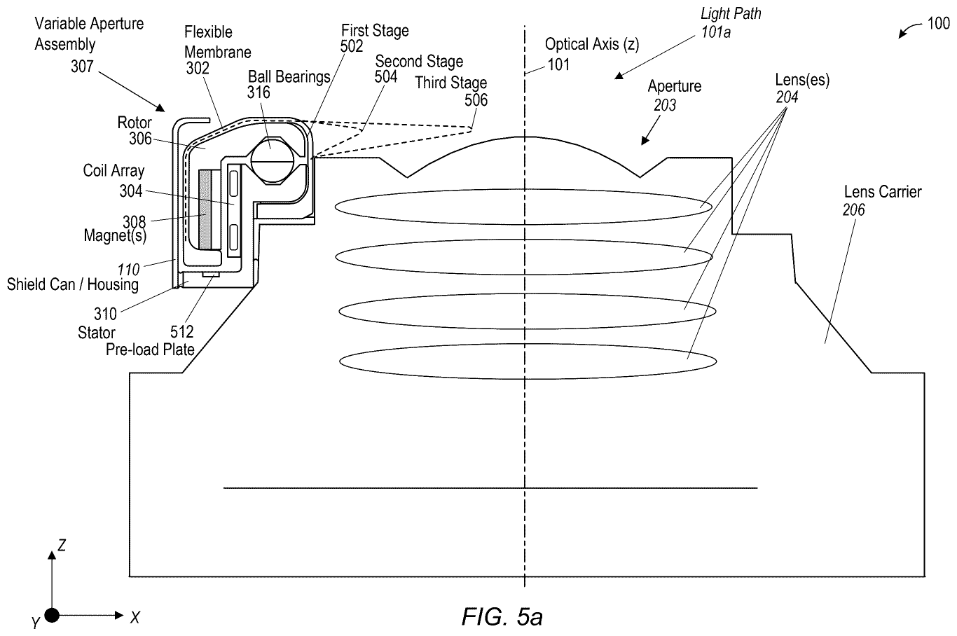

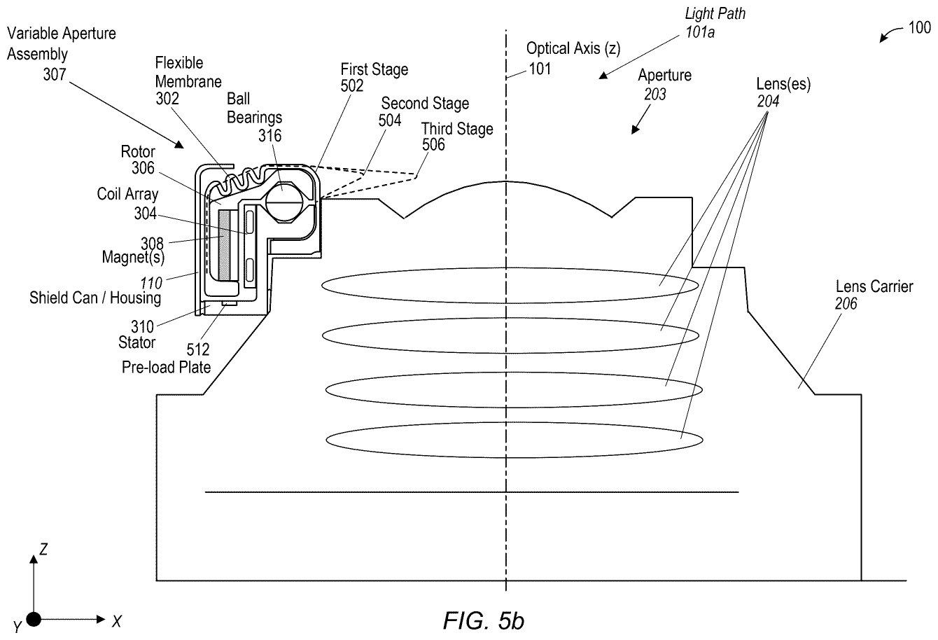

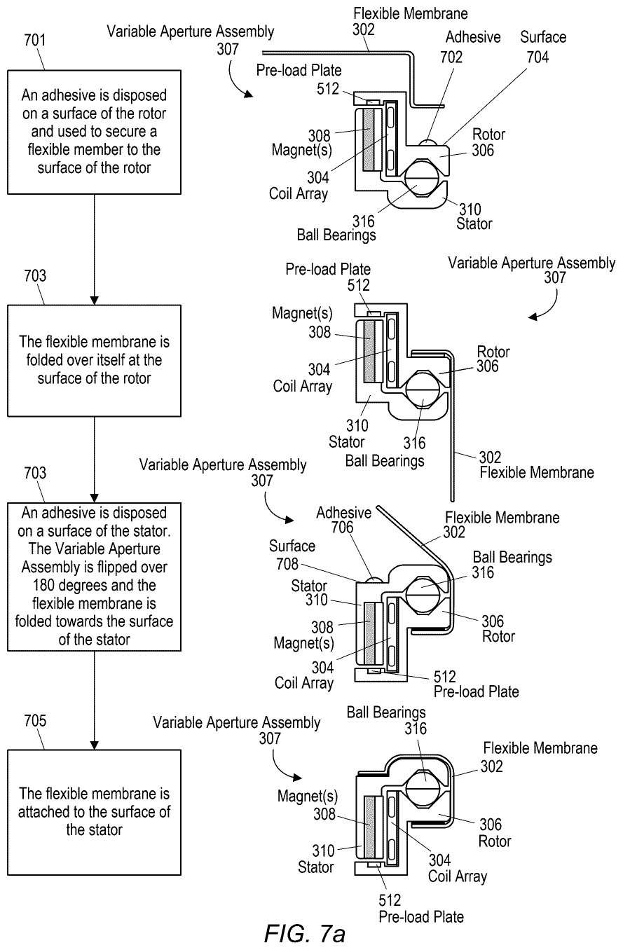

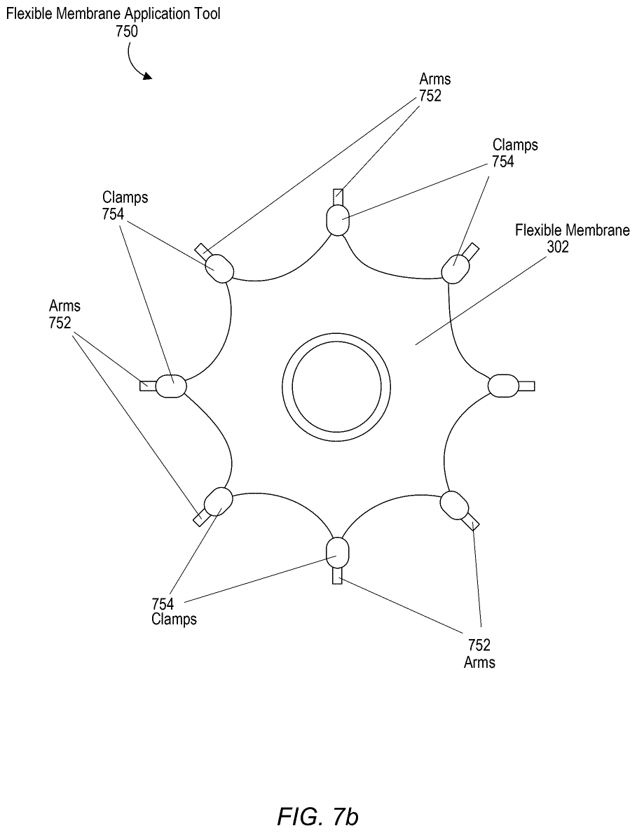

FIGS. 5a and 5b illustrate cross-sectional views of a camera having a variable aperture assembly 307 with a flexible membrane 302 that may, for example, change the diameter of an aperture/opening to change an amount of light that reaches lenses of an optical assembly and/or an image sensor in small form factor cameras, according to at least some embodiments. The variable aperture assembly 507 of FIGS. 7a and 7b may include one or more same or similar features as the features described with respect to or illustrated in FIGS. 1, 2, 3, 4a, 4b, 4c, 6, 7a, 7b, 8, 9, 10, 11, 12, 13, 14, 15, 16, and 17. The example X-Y-Z coordinate system shown in FIGS. 5a and 5b may be used to discuss aspects of components and/or systems, and may apply to embodiments described throughout this disclosure.

As shown in FIGS. 5a and 5b, the variable aperture assembly 307 may be positioned within the shield can 110 and around the aperture 203 of the camera 100. The flexible membrane 302 may be fixedly attached to the rotor 306 over an upward facing surface of the rotor 306. The flexible membrane 302 may also be fixedly attached to the stator 310 on a surface of the stator 310 facing inward (e.g., towards the optical axis 101). The ball bearings 316 permit the rotor 306 to rotate about the optical axis 101 and relative to the stator 310. The magnets 308 fixedly attached to rotor 306 and adjacent the coils of the coil array 304 fixedly attached to the stator 310 cause rotation of the rotor 306 relative to the stator 310. The pre-load plate 512 fixedly attached to the stator 310 may load or draw the rotor 306 towards the magnets 308 and against the ball bearings 316 so that rotor 306 rotate using the ball bearings 316 and relative to the stator 310 while maintaining a distance between the rotor 306 and the stator 310.

When the coils of the coil array 304 receive an electrical current, the coils on the stator 310 interact with the magnetic field produced by the adjacent magnets 308 on the rotor 306 generating Lorentz forces causing rotation of the rotor 306 relative to the stator 310. As the rotor 306 rotates from a first stage 502 and in a first direction relative to the stator 310, the flexible membrane 302 extends increasingly further into the aperture 203 via an hyperboloid effect reducing the diameter of the aperture 203 to a second stage 504. As the rotor 306 continues to rotate from the second stage 504 and in the first direction relative to the stator 310, the flexible membrane 302 extends increasingly further into the aperture 203 via the hyperboloid effect reducing the diameter of the aperture 203 to a third stage 506. Subsequently, the rotor 306 may continue to rotate from the third stage 506 and in the first direction relative to the stator 310 until the flexible membrane 302 extends into the aperture 203 via the hyperboloid effect and completely closing the aperture 203.

When the coils of the coil array 304 receive an electrical current, the coils on the stator 310 interact with the magnetic field produced by the adjacent magnets 308 on the rotor 306 generating Lorentz forces causing rotation of the rotor 306 relative to the stator 310. As the rotor 306 rotates from a closed aperture position and in a second direction, opposite the first direction and relative to the stator 310, the flexible membrane 302 retracts away from the optical axis 101 via the hyperboloid effect increasing the diameter of the aperture 203 to the third stage 506. As the rotor 306 continues to rotate from the third stage 506 and in the second direction relative to the stator 310, the flexible membrane 302 retracts further out of the aperture 203 via the hyperboloid effect further reducing the diameter of the aperture 203 to the second stage 504. Subsequently, the rotor 306 may continue to rotate from the second stage 504 and in the second direction relative to the stator 310 until the flexible membrane 302 extends out of the aperture 203 via the hyperboloid effect and completely opening the aperture 203. In some aspects, as shown in FIG. 5a, the flexible membrane 302 may, for example, have enough elasticity to reside against the top surface of the rotor 306 when in the first stage 502 and still extend out into the second stage 504, the third stage 506, and the closed position. In some aspects, as shown in FIG. 5b, the flexible membrane 302 may, for example, be bunched up over the top surface of the rotor 306 when in first stage 502 and have slack (due to the bunching) to extend out into the second stage 504, the third stage 506, and the closed position.

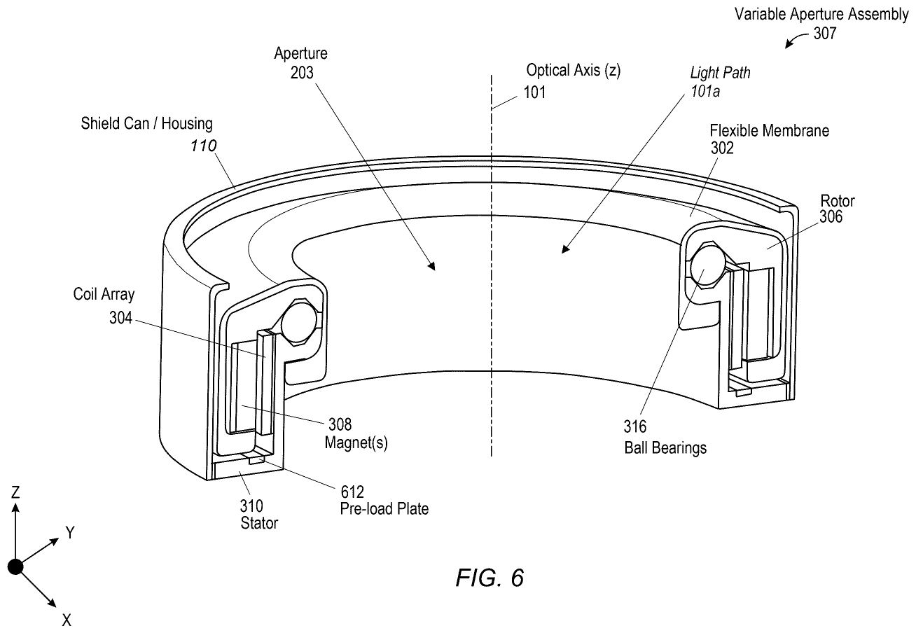

FIG. 6 illustrates a cross-sectional perspective view of components of an example variable aperture assembly 307 with a flexible membrane 302, according to at least some embodiments. The variable aperture assembly 307 of FIG. 6 may include one or more same or similar features as the features described with respect to or illustrated in FIGS. 1, 2, 3, 4a, 4b, 4c, 5a, 5b, 7, 8, 9, 10, 11, 12, 13, 14, 15, 16, and 17. The example X-Y-Z coordinate system shown in FIG. 6 may be used to discuss aspects of components and/or systems, and may apply to embodiments described throughout this disclosure.

As shown in FIG. 6, the variable aperture assembly 307 may be circular in shape so that it can surround the optical axis 101 and the aperture 203 of the camera 100. The flexible membrane 302 may be fixedly attached to the rotor 306 over a surface of the rotor 306. In some aspects, a lubricant (e.g., grease) may be applied to surfaces of the rotor 306 that receive the flexible membrane 302 to reduce friction. The flexible membrane 302 may also be fixedly attached to the stator 310 on a surface of the stator 310 facing inward (e.g., towards the optical axis 101). The ball bearings 316 may permit the rotor 306 to rotate about the optical axis 101 and relative to the stator 310. The magnets 308 fixedly attached to the rotor 306 and adjacent the coils of the coil array 304 fixedly attached to the stator 310 cause rotation of the rotor 306 relative to the stator 310. The pre-load plate 512 fixedly attached to the stator 310 may load or draw the rotor 306 towards the magnets 308 and against the ball bearings 316 so that rotor 306 rotate using the ball bearings 316 and relative to the stator 310 while maintaining a distance between the rotor 306 and the stator 310.

FIG. 7a illustrates an example method 700 of assembling a variable aperture assembly with a flexible membrane along with representational diagrams, according to at least some embodiments. The method 700 of FIG. 7a may include one or more same or similar features as the features and/or one or more similar method steps as described with respect to or illustrated in FIGS. 1, 2, 3, 4a, 4b, 4c, 5a, 5b, 6, 7b, 8, 9, 10, 11, 12, 13, 14, 15, 16, and 17. At step 701, an adhesive 702 may be positioned or disposed on a surface 704 of the rotor 306 for securing the flexible membrane 302 to the surface 704 of the rotor 306. For example, the flexible membrane 302 may have a donut-shape. Using a flexible membrane application tool 750 (as shown in FIG. 7b), an inner edge of the donut-shape may be fixedly attached at the surface 704 of the rotor 306 via the adhesive 702. At step 703, the flexible membrane 302 may be folded over itself at the surface 704 of the rotor 306. At step 705, an adhesive 706 may be positioned or disposed on a surface 708 of the stator 310. The variable aperture assembly 307 may be flipped over 180 degrees and the flexible membrane 302 is folded towards to the surface 708 of the stator 310. At step 707, Using a flexible membrane application tool 750 (as shown in FIG. 7b), an outer edge of the donut-shape may be fixedly attached at the surface 708 of the stator 310 via the adhesive 706. Subsequently, the variable aperture assembly 307 may be positioned around the perimeter of the aperture 203 of the camera 100.

FIG. 7b illustrates an example flexible membrane application tool 750 for assembling a variable aperture assembly, according to at least some embodiments. The flexible membrane application tool 750 of FIG. 7b may include one or more same or similar features as the features and/or one or more similar method steps as described with respect to or illustrated in FIGS. 1, 2, 3, 4a, 4b, 4c, 5a, 5b, 6, 7a, 8, 9, 10, 11, 12, 13, 14, 15, 16, and 17. As described herein, for example with respect to step 701 of method 700, an adhesive 702 may be positioned or disposed on a surface 704 of the rotor 306 for securing the flexible membrane 302 to the surface 704 of the rotor 306. For example, the flexible membrane 302 may have a donut-shape. Using a flexible membrane application tool 750 (as shown in FIG. 7b), an inner edge of the donut-shape may be fixedly attached at the surface 704 of the rotor 306 via the adhesive 702. Also, as described herein, for example with respect to step 707 of method 700, using the flexible membrane application tool 750 (as shown in FIG. 7b), an outer edge of the donut-shape may be fixedly attached at the surface 708 of the stator 310 via the adhesive 706. Subsequently, the variable aperture assembly 307 may be positioned around the perimeter of the aperture 203 of the camera 100. As shown in FIG. 7b, the flexible membrane application tool 750 may include a plurality of arms 752 with respective clamps 754 attached at one end of the arms. The clamps 754 may hold a portion of the donut-shaped flexible membrane 302 so that the arms 752 may pull the flexible membrane 302 away from a center so that steps 701 and 707 of method 700 may be performed. The flexible membrane application tool 750 may allow the flexible membrane 302 to be aligned with the remaining variable aperture assembly 307 and to be attached to the rotor 306 and the stator 310, as described herein.

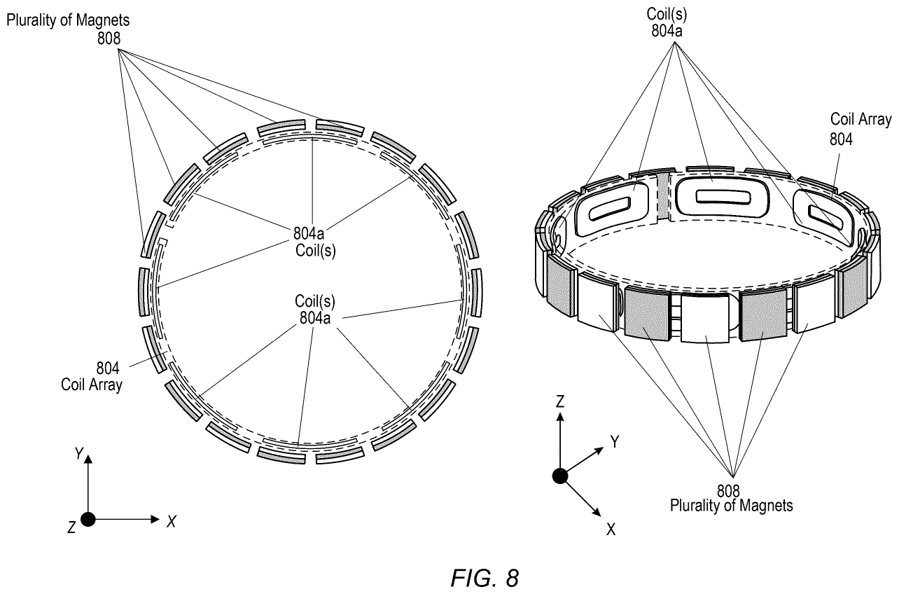

The actuator(s) of the variable aperture assembly 307 (e.g., the coils and the magnets) may have a variety of configurations to move/rotate the rotor 306 about the optical axis 101 and relative to the stator 310. FIG. 8 illustrates an overhead and perspective view of an example set of magnets and coil array for actuating a variable aperture assembly with a flexible membrane, according to at least some embodiments. The example set of magnets and coil array of FIG. 8 may include one or more same or similar features as the features described with respect to or illustrated in FIGS. 1, 2, 3, 4a, 4b, 4c, 5a, 5b, 6, 7a, 7b, 9, 10, 11, 12, 13, 14, 15, 16, and 17. The example X-Y-Z coordinate system shown in FIG. 8 may be used to discuss aspects of components and/or systems, and may apply to embodiments described throughout this disclosure.

As shown in FIG. 8, the example set of magnets and coil array for actuating a variable aperture assembly (e.g., the variable aperture assemblies 307, 1307) with a flexible membrane may include a coil array 804 including a plurality of coils 804a and a plurality of magnets 808. The example set of magnets and coil array may be used to actuate a variable aperture assembly (e.g., variable door assembly 307, 1307) as described herein by providing a current through the coils 804a while the coils 804a are within the magnetic field produced by the magnets 808 and generating Lorentz forces to move the rotor 306 relative to the stator 310. The plurality of coils 804a of the coil array 804 may be evenly distributed and positioned around in a circular configuration the example set of magnets and coil array and face inward towards a center (e.g., the optical axis 101). In some aspects as shown in FIG. 8, the example set of magnets and coil array may have a 2-phase design with eight (8) coils including four (4) coils for a first phase or circuit of the 2-phase design and a remaining four (4) coils for a second phase or circuit of the 2-phase design. Respective magnets of the plurality of magnets 808 may be evenly distributed and positioned in a circular configuration around the example set of magnets and coil array and face outward away from the center (e.g., the optical axis 101) such that respective magnets of the plurality of magnets 808 are adjacent respective coils 804a and further from the center. In some aspects, respective magnets of the plurality of magnets 808 may have opposite polarity compared to adjacent magnets positioned around the example set of magnets and coil array. In some aspects, respective magnets of the plurality of magnets 808 and/or respective coils 804a of the coil array 804 may have flat surfaces facing towards and away from the center (e.g., the optical axis 101). In some aspects, respective magnets of the plurality of magnets 808 and/or respective coils 804a of the coil array 804 may have curved surfaces facing towards and away from the center (e.g., the optical axis 101). The curved surfaces may have an amount of curvature such that when placed adjacent to each other produce a circular configuration.

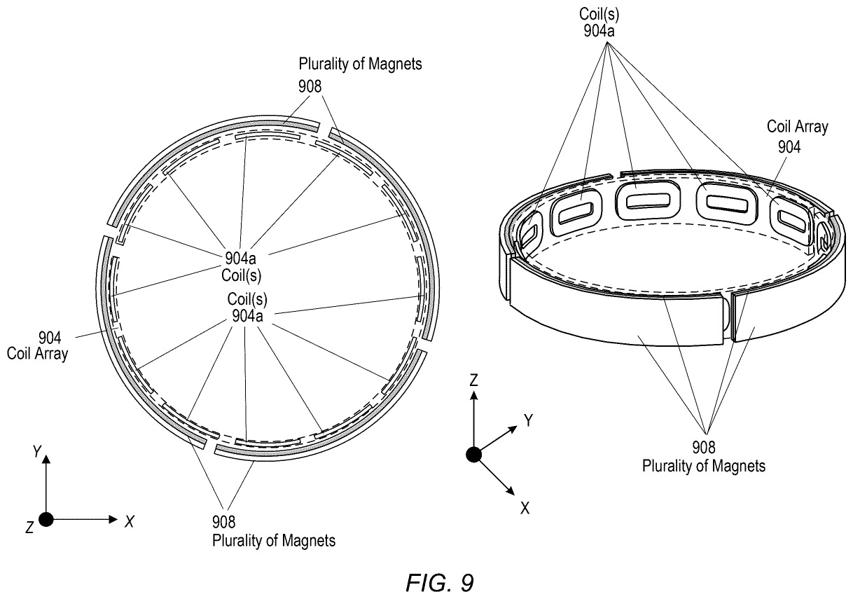

FIG. 9 illustrates an overhead and perspective view of another example set of magnets and coil array for actuating a variable aperture assembly with a flexible membrane, according to at least some embodiments. The example set of magnets and coil array of FIG. 9 may include one or more same or similar features as the features described with respect to or illustrated in FIGS. 1, 2, 3, 4a, 4b, 4c, 5a, 5b, 6, 7a, 7b, 8, 10, 11, 12, 13, 14, 15, 16, and 17. The example X-Y-Z coordinate system shown in FIG. 9 may be used to discuss aspects of components and/or systems, and may apply to embodiments described throughout this disclosure.

As shown in FIG. 9, the example set of magnets and coil array for actuating a variable aperture assembly (e.g., variable door assembly 307, 1307) with a flexible membrane may include a coil array 904 including a plurality of coils 904a and a plurality of magnets 908. The example set of magnets and coil array may be used to actuate a variable aperture assembly (e.g., variable door assembly 307, 1307) as described herein by providing a current through the coils 904a while the coils 904a are within the magnetic field produced by the magnets 908 and generating Lorentz forces to move the rotor 306 relative to the stator 310. The plurality of coils 904a of the coil array 904 may be evenly distributed and positioned around in a circular configuration the example set of magnets and coil array and face inward towards a center (e.g., the optical axis 101). In some aspects as shown in FIG. 9, the example set of magnets and coil array may have a 3-phase design with twelve (12) coils including four (4) coils for a first phase or circuit of the 3-phase design, four (4) coils for a second phase or circuit of the 3-phase design, and a remaining four (4) coils for a third phase or circuit of the 3-phase design. Respective magnets of the plurality of magnets 908 may be evenly distributed and positioned in a circular configuration around the example set of magnets and coil array and face outward away from the center (e.g., the optical axis 101) such that respective magnets of the plurality of magnets 908 are adjacent respective coils 904a and further from the center. In some aspects, respective magnets of the plurality of magnets 908 may have opposite polarity compared to adjacent magnets positioned around the example set of magnets and coil array. In some aspects, respective magnets of the plurality of magnets 908 and/or respective coils 904a of the coil array 904 may have flat surfaces facing towards and away from the center (e.g., the optical axis 101). In some aspects, respective magnets of the plurality of magnets 908 and/or respective coils 904a of the coil array 904 may have curved surfaces facing towards and away from the center (e.g., the optical axis 101). The curved surfaces may have an amount of curvature such that when placed adjacent to each other produce a circular configuration.

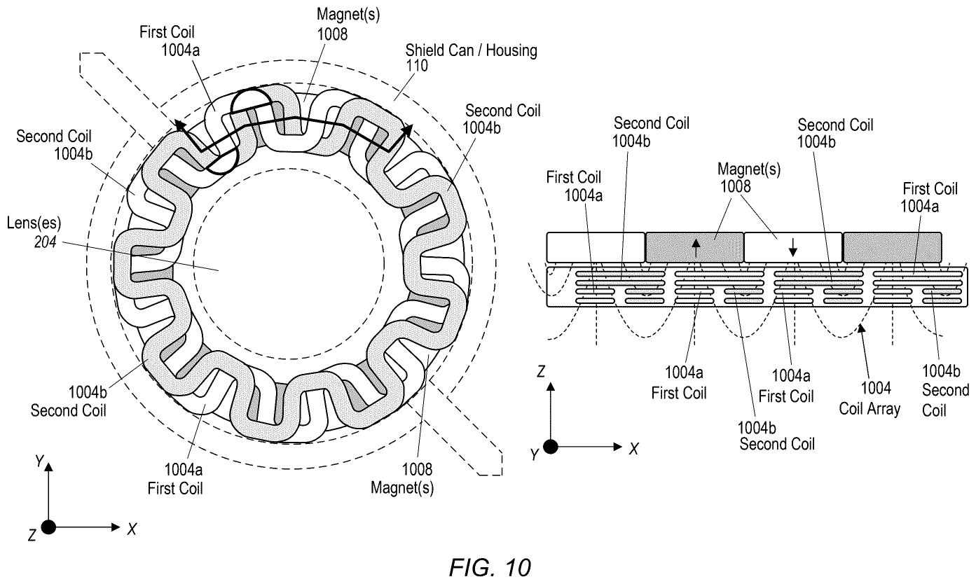

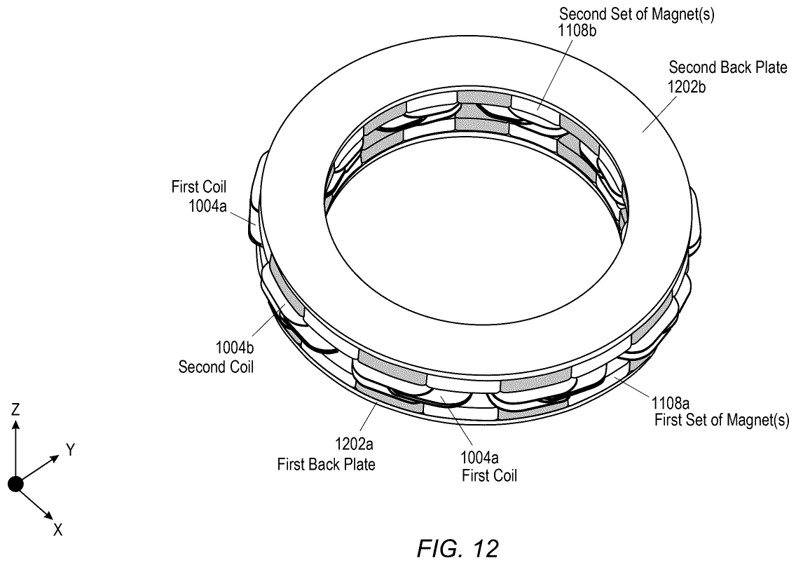

FIG. 10 illustrates an overhead and cross-sectional view of an example set of magnets and coils for actuating a variable aperture assembly with a flexible membrane, according to at least some embodiments. The example set of magnets and coil array of FIG. 12 may include one or more same or similar features as the features described with respect to or illustrated in FIGS. 1, 2, 3, 4a, 4b, 4c, 5a, 5b, 6, 7a, 7b, 8, 9, 11, 12, 13, 14, 15, 16, and 17. The example X-Y-Z coordinate system shown in FIG. 10 may be used to discuss aspects of components and/or systems, and may apply to embodiments described throughout this disclosure.

As shown in FIG. 10, the example set of magnets and coils for actuating a variable aperture assembly (e.g., variable door assembly 307, 1307) with a flexible membrane may include a first coil 1004a, a second coil 1004b, and a plurality of magnets 1008. The example set of magnets and coils may be used to actuate a variable aperture assembly (e.g., variable door assembly 307, 1307) as described herein by providing a current through the coils 1004a and 1004b while the coils 1004a and 1004b are within the magnetic field produced by the magnets 1008 and generating Lorentz forces to move the rotor 506 relative to the stator 510. As shown in FIG. 10, the magnets 1008, the first coil 1004a, and the second coil 1004b may form a donut shape or circular shape around the center (e.g., the optical axis 101). The magnets 1008 may be stacked or positioned over the first coil 1004a and the second coil 1004b in a direction parallel to the optical axis 101. In some aspects, the first coil 1004a and the second coil 1004b may be stacked or positioned over the magnets 1008. The first coil 1004a and the second coil 1004b may have undulating configurations extending towards and away from the center (e.g., the optical axis 101) within the donut or circular configuration. The first coil 1004a and the second coil 1004b may also have undulating configurations extending upwards and downward (e.g., along the optical axis 101) within the donut or circular configuration so that the first coil 1004 and the second coil 1004b may intertwine with each other or weave through each other. The magnets 1008 may be evenly distributed and positioned around in a circular configuration aligned with the first coil 1004a and the second coil 1004b and may have broad or broader surfaces facing upwards and downwards parallel to the optical axis 101 and adjacent the first coil 1004a and the second coil 1004b. In some aspects, respective magnets of the plurality of magnets 1008 may have opposite polarity compared to adjacent magnets positioned around the circular configuration.

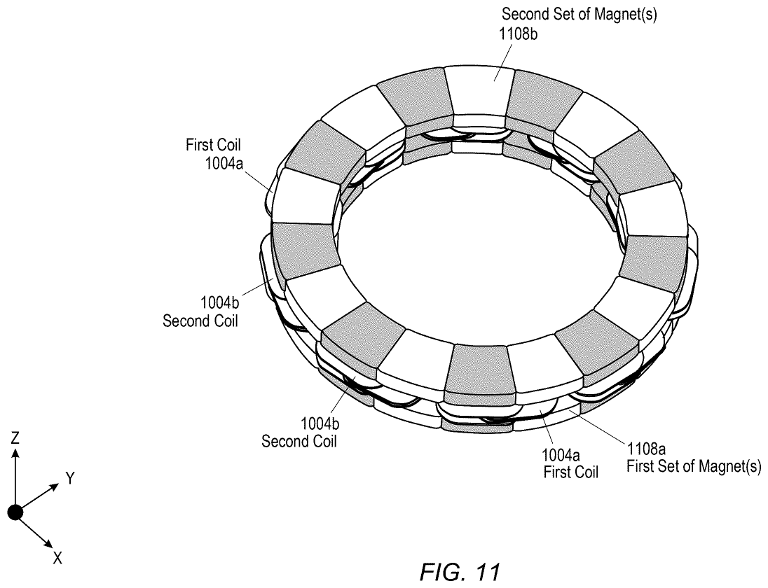

FIG. 11 illustrates a perspective view of another example set of magnets and coils for actuating a variable aperture assembly with a flexible membrane, according to at least some embodiments. The example set of magnets and coils of FIG. 11 may include one or more same or similar features as the features described with respect to or illustrated in FIGS. 1, 2, 3, 4a, 4b, 4c, 5a, 5b, 6, 7a, 7b, 8, 9, 10, 12, 13, 14, 15, 16, and 17. The example X-Y-Z coordinate system shown in FIG. 11 may be used to discuss aspects of components and/or systems, and may apply to embodiments described throughout this disclosure.

As shown in FIG. 11, the example set of magnets and coils for actuating a variable aperture assembly (e.g., variable door assembly 507, 1507) with a flexible membrane may include the first coil 1004a, the second coil 1004b, a first set of magnets 1108a, and a second set of magnets 1108b. The example set of magnets and coils may be used to actuate a variable aperture assembly (e.g., variable door assembly 307, 1307) as described herein by providing a current through the coils 1004a and 1004b while the coils 1004a and 1004b are within the magnetic field produced by the magnets 1108a and 1108b and generating Lorentz forces to move the rotor 306 relative to the stator 310. As shown in FIG. 11, the first set of magnets 1108a, the second set of magnets 1108b, the first coil 1004a, and the second coil 1004b may form a donut shape or circular shape around the center (e.g., the optical axis 101). The first set of magnets 1108a may be stacked or positioned under the first coil 1004a and the second coil 1004b in a direction parallel to the optical axis 101. The second set of magnets 1108b may be stacked or positioned over the first coil 1004a and the second coil 1004b in a direction parallel to the optical axis 101. Thus, the first coil 1004a and the second coil 1004b may be sandwiched between the first set of magnets 1108a and the second set of magnet 1108b. The first coil 1004a and the second coil 1004b may have undulating configurations extending towards and away from the center (e.g., the optical axis 101) within the donut or circular configuration. The first coil 1004a and the second coil 1004b may also have undulating configurations extending upwards and downward (e.g., along the optical axis 101) within the donut or circular configuration so that the first coil 1004 and the second coil 1004b may intertwine with each other or weave through each other. The first set of magnets 1108a and the second set of magnets 1108b may be evenly distributed and positioned around in a circular configuration aligned with the first coil 1004a and the second coil 1004b and may have broad or broader surfaces facing upwards and downwards parallel to the optical axis 101 and adjacent the first coil 1004a and the second coil 1004b. In some aspects, respective magnets of the plurality of magnets 1008 may have opposite polarity compared to adjacent magnets positioned around the circular configuration. In some aspects, respective magnets of the first set of magnets 1108a having a first polarity may be vertically aligned with respective magnets of the second set of magnets 1108b having the first polarity. Similarly, respective magnets of the first set of magnets 1108a having a second polarity, different than the first polarity, may be vertically aligned with respective magnets of the second set of magnets 1108b having the second polarity. In some aspects, due to having the first set of magnets 1108a above the first coil 1004a and the second coil 1004b and the second set of magnets 1108b below the first coil 1004a and the second coil 1004b as provided in FIG. 11, the dual set of magnets may produce higher peak torque for same amount of amperage through the first and second coils 1004a and 1004b compared to the single set of magnets as provided in FIG. 10.

FIG. 12 illustrates a perspective view of yet another example set of magnets and coils for actuating a variable aperture assembly with a flexible membrane, according to at least some embodiments. The example set of magnets and coils of FIG. 12 may include one or more same or similar features as the features described with respect to or illustrated in FIGS. 1, 2, 3, 4a, 4b, 4c, 5a, 5b, 6, 7a, 7b, 8, 9, 10, 11, 13, 14, 15, 16, and 17. The example X-Y-Z coordinate system shown in FIG. 12 may be used to discuss aspects of components and/or systems, and may apply to embodiments described throughout this disclosure.

As shown in FIG. 12, the example set of magnets and coils for actuating a variable aperture assembly (e.g., variable door assembly 307, 1307) with a flexible membrane may include the first coil 1004a, the second coil 1004b, the first set of magnets 1108a, the second set of magnets 1108b, a first back plate 1002a, and a second back plate 1002b. The example set of magnets and coils may be used to actuate a variable aperture assembly (e.g., variable door assembly 307, 1307) as described herein by providing a current through the coils 1004a and 1004b while the coils 1004a and 1004b are within the magnetic field produced by the magnets 1108a and 1108b and generating Lorentz forces to move the rotor 306 relative to the stator 310. As shown in FIG. 10, the first set of magnets 1108a, the second set of magnets 1108b, the first coil 1004a, the second coil 1004b, the first back plate 1002a, and the second back plate 1002b may form a donut shape or circular shape around the center (e.g., the optical axis 101). The first set of magnets 1108a may be stacked or positioned under the first coil 1004a and the second coil 1004b in a direction parallel to the optical axis 101. The second set of magnets 1108b may be stacked or positioned over the first coil 1004a and the second coil 1004b in a direction parallel to the optical axis 101. Thus, the first coil 1004a and the second coil 1004b may be sandwiched between the first set of magnets 1108a and the second set of magnet 1108b. The first coil 1004a and the second coil 1004b may have undulating configurations extending towards and away from the center (e.g., the optical axis 101) within the donut or circular configuration. The first coil 1004a and the second coil 1004b may also have undulating configurations extending upwards and downward (e.g., along the optical axis 101) within the donut or circular configuration so that the first coil 1004 and the second coil 1004b may intertwine with each other or weave through each other. The first set of magnets 1108a and the second set of magnets 1108b may be evenly distributed and positioned around in a circular configuration aligned with the first coil 1004a and the second coil 1004b and may have broad or broader surfaces facing upwards and downwards parallel to the optical axis 101 and adjacent the first coil 1004a and the second coil 1004b. In some aspects, respective magnets of the plurality of magnets 1008 may have opposite polarity compared to adjacent magnets positioned around the circular configuration. In some aspects, respective magnets of the first set of magnets 1108a having a first polarity may be vertically aligned with respective magnets of the second set of magnets 1108b having the first polarity. Similarly, respective magnets of the first set of magnets 1108a having a second polarity, different than the first polarity, may be vertically aligned with respective magnets of the second set of magnets 1108b having the second polarity. The first back plate 1002a may be stacked or positioned under the first coil 1004a and the second coil 1004b in a direction parallel to the optical axis 101. The second back plate 1002b may be stacked or positioned over the first coil 1004a and the second coil 1004b in a direction parallel to the optical axis 101. Thus, the first set of magnets 1108a, the first coil 1004a, the second coil 1004b, and the second set of magnets 1108b may be sandwiched between the first back plate 1002a and the second back plate 1002b. In some aspects, due to having the first set of magnets 1108a above the first coil 1004a and the second coil 1004b and the second set of magnets 1108b below the first coil 1004a and the second coil 1004b and all sandwiched between the first back plate 1002a and the second back plate 1002b as provided in FIG. 10, the dual set of magnets with back plates may produce higher peak torque for same amount of amperage through the first and second coils 1004a and 1004b compared to the dual set of magnets as provided in FIG. 11 and the single set of magnets as provided in FIG. 10.

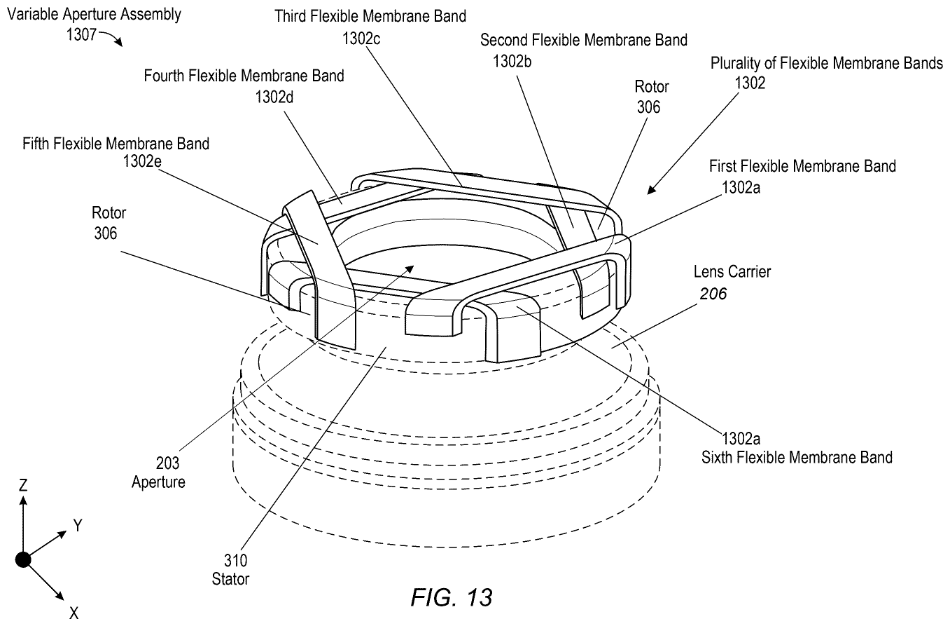

FIG. 13 illustrates a perspective view of a variable aperture assembly 1307 with multiple flexible membranes that may, for example, change the diameter of an aperture/opening to change an amount of light that reaches lenses of an optical assembly and/or an image sensor in small form factor cameras, according to at least some embodiments. The variable aperture assembly 1307 of FIG. 13 may include one or more same or similar features as the features described with respect to or illustrated in FIGS. 1, 2, 3, 4a, 4b, 4c, 5a, 5b, 6, 7a, 7b, 8, 9, 10, 11, 12, 14, 15, 16, and 17. The example X-Y-Z coordinate system shown in FIG. 13 may be used to discuss aspects of components and/or systems, and may apply to embodiments described throughout this disclosure.

As shown in FIG. 13, the variable aperture assembly 1307 may include one or more same or similar features as the variable aperture assembly 307 described herein. The variable aperture assembly 1307 may include the rotor 306, the stator 310, and a plurality of flexible membrane bands 1302. Respective flexible membrane bands of the plurality of flexible membrane band 1302 may include one or more same or similar characteristics as the flexible membrane 302 described herein. Respective flexible membrane bands of the plurality of flexible membrane bands 1302 may be in the form of strips or rectangular shapes with two parallel sides being longer than two other parallel sides. The plurality of flexible membrane bands 1302 may include a first flexible membrane band 1302a, a second flexible membrane band 1302b, a third flexible membrane band 1302c, a fourth flexible membrane band 1302d, a fifth flexible membrane band 1302e, and a sixth flexible membrane band 1302f. As described further herein, one end of the respective flexible membrane bands 1302 may be fixedly attached to the rotor 306 and the other end of the respective flexible membrane bands 1302 may be fixedly attached to the stator 310 so that when the rotor 306 moves or rotates relative to the stator 310, the respective flexible membrane bands 1302 shift over the aperture 203 changing the diameter of the aperture 203 and changing or modulating the amount of light that pass through the aperture 203.

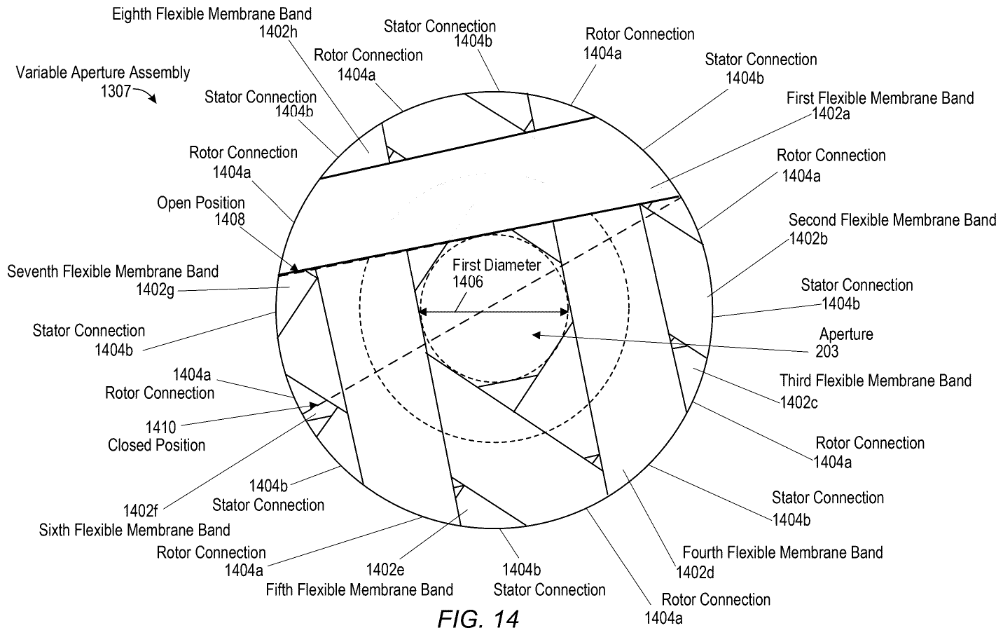

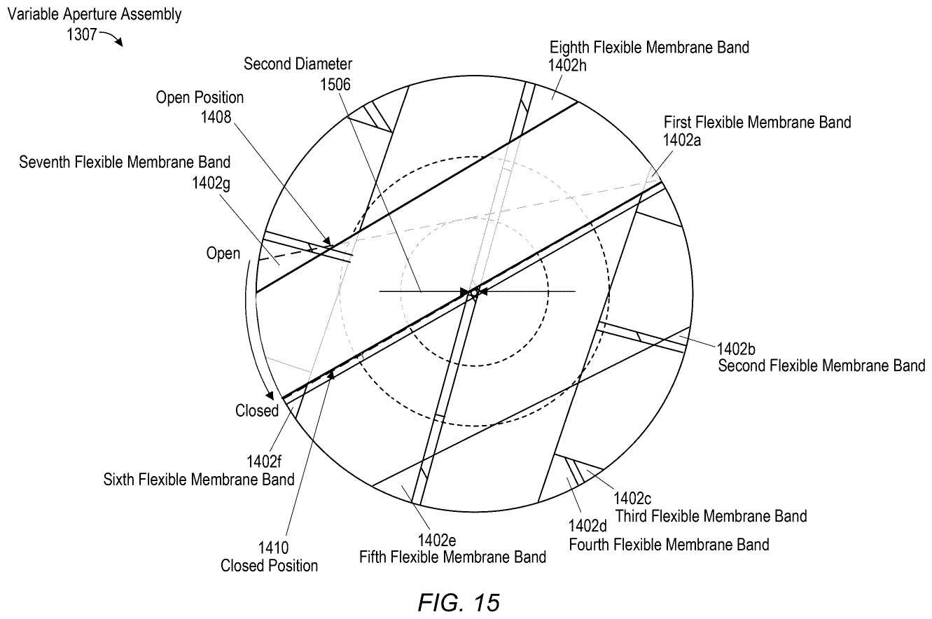

FIGS. 14 and 15 illustrate overhead views of a variable aperture assembly with multiple flexible membranes that may, for example, change the diameter of an aperture/opening to change an amount of light that reaches lenses of an optical assembly and/or an image sensor in small form factor cameras, according to at least some embodiments. FIG. 14 illustrates an overhead view of the variable aperture assembly when the multiple flexible membranes are in an open position. FIG. 15 illustrates an overhead view of the variable aperture assembly when the multiple flexible membranes are in a closed position. The variable aperture assembly 1307 of FIGS. 14 and 15 may include one or more same or similar features as the features described with respect to or illustrated in FIGS. 1, 2, 3, 4a, 4b, 4c, 5a, 5b, 6, 7a, 7b, 8, 9, 10, 11, 12, 13, 16, and 17. The example X-Y-Z coordinate system shown in FIGS. 14 and 15 may be used to discuss aspects of components and/or systems, and may apply to embodiments described throughout this disclosure.

As shown in FIG. 14, the variable aperture assembly 1307 may include the rotor 306, the stator 310, and a plurality of flexible membrane bands 1402. The plurality of flexible membrane bands 1402 may include one or more same or similar features as the plurality of flexible membrane bands 1302 illustrated in FIG. 13. For example, respective flexible membrane bands of the plurality of flexible membrane bands 1402 may be in the form of strips or rectangular shapes with two parallel sides being longer than two other parallel sides. The plurality of flexible membrane bands 1402 may include a first flexible membrane band 1402a, a second flexible membrane band 1402b, a third flexible membrane band 1402c, a fourth flexible membrane band 1402d, a fifth flexible membrane band 1402e, a sixth flexible membrane band 1402f, a seventh flexible membrane band 1402g, and an eighth flexible membrane band 1402h. One end of the respective flexible membrane bands 1402 may be fixedly attached to the rotor 306 and the other end of the respective flexible membrane bands 1402 may be fixedly attached to the stator 310. For example, the first flexible membrane band 1402a, the second flexible membrane band 1402b, the third flexible membrane band 1402c, the fourth flexible membrane band 1402d, the fifth flexible membrane band 1402e, the sixth flexible membrane band 1402f, the seventh flexible membrane band 1402g, and the eighth flexible membrane band 1402h may be fixedly attached to the rotor 506 at respective rotor connection points 1404a and to the stator 510 at respective stator connection point 1404b. As shown in FIG. 14, the variable aperture assembly 1307 may be in a fully open position 1408. In the fully open position 1408, the flexible membrane bands 1402 of the variable aperture assembly 1307 produces the aperture 203 having a first diameter 1406, a largest or maximum diameter, for allowing/permitting light to pass therethrough. When the rotor 306 moves or rotates relative to the stator 310, the respective flexible membrane bands 1402 shift over the aperture 203 changing the diameter of the aperture 203 and changing or modulating the amount of light that pass through the aperture 203. As the rotor 306 rotates or moves relative to the stator 310, the flexible membrane bands 1402 of the variable aperture assembly 1307 may shift over the aperture 203 reducing the diameter of the aperture 203 until the flexible membrane bands 1402 reach the fully actuated or fully closed position 1410 and the diameter of the aperture 203 becomes zero.

As shown in FIG. 15, the variable aperture assembly 1307 may be in the fully actuated or fully closed position 1410. In the fully closed position 1410, the flexible membrane bands 1402 may have fully shifted to cover the entire space over the aperture 203 decreasing the diameter of the aperture 203 to zero, preventing light to pass therethrough. For example, the rotor 306 may have rotated a distance about the optical axis 101 and relative to the stator 310, causing the flexible membrane bands 1402 to shift and completely cover the aperture 203 closing the aperture 203. Using the variable aperture assembly 1307 with the flexible membrane bands 1402 rather than the variable aperture assembly with the plurality of blades, illustrated in FIG. 3, mitigates problems with the plurality of blades. For example, compared to the variable aperture assembly with the plurality of blades that produce a hexagonal opening when in the closed position, the variable aperture assembly 1307 with the flexible membrane bands 1402 may be able to fully close the aperture 203 and prevent light from reaching the lenses and/or image sensor of the camera module from the external environment and through the aperture 203.

FIG. 16 illustrates a schematic representation of an example device 1600 that may include a camera (e.g., as described herein with respect FIGS. 1, 2, 3, 4a, 4b, 4c, 5a, 5b, 6, 7a, 7b, 8, 9, 10, 11, 12, 13, 14, 15, and 16), in accordance with some embodiments. In some embodiments, the device 1600 may be a mobile device and/or a multifunction device. In various embodiments, the device 1600 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1600 may include a display system 1602 (e.g., comprising a display and/or a touch-sensitive surface) and/or one or more cameras 1604. In some non-limiting embodiments, the display system 1602 and/or one or more front-facing cameras 1604a may be provided at a front side of the device 1600, e.g., as indicated in FIG. 16. Additionally, or alternatively, one or more rear-facing cameras 1604b may be provided at a rear side of the device 1600. In some embodiments comprising multiple cameras 1604, some or all of the cameras may be the same as, or similar to, each other. Additionally, or alternatively, some or all of the cameras may be different from each other. In various embodiments, the location(s) and/or arrangement(s) of the camera(s) 1604 may be different than those indicated in FIG. 16.

Among other things, the device 1600 may include memory 1606 (e.g., comprising an operating system 1608 and/or application(s)/program instructions 1610), one or more processors and/or controllers 1612 (e.g., comprising CPU(s), memory controller(s), display controller(s), and/or camera controller(s), etc.), and/or one or more sensors 1616 (e.g., orientation sensor(s), proximity sensor(s), and/or position sensor(s), etc.). In some embodiments, the device 1600 may communicate with one or more other devices and/or services, such as computing device(s) 1618, cloud service(s) 1620, etc., via one or more networks 1622. For example, the device 1600 may include a network interface (e.g., network interface 1610) that enables the device 1600 to transmit data to, and receive data from, the network(s) 1622. Additionally, or alternatively, the device 1600 may be capable of communicating with other devices via wireless communication using any of a variety of communications standards, protocols, and/or technologies.

FIG. 17 illustrates a schematic block diagram of an example computing device, referred to as computer system 1700, that may include or host embodiments of a camera (e.g., as described herein with respect to FIGS. 1, 2, 3, 4a, 4b, 4c, 5a, 5b, 6, 7a, 7b, 8, 9, 10, 11, 12, 13, 14, 15, and 16). In addition, computer system 1700 may implement methods for controlling operations of the camera and/or for performing image processing images captured with the camera. In some embodiments, the device 1700 (described herein with reference to FIG. 17) may additionally, or alternatively, include some or all of the functional components of the computer system 1700 described herein.

The computer system 1700 may be configured to execute any or all of the embodiments described above. In different embodiments, computer system 1700 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1700 includes one or more processors 1702 coupled to a system memory 1704 via an input/output (I/O) interface 1706. Computer system 1700 further includes one or more cameras 1708 coupled to the I/O interface 1706. Computer system 1700 further includes a network interface 1710 coupled to I/O interface 1706, and one or more input/output devices 1712, such as cursor control device 1714, keyboard 1716, and display(s) 1718. In some cases, it is contemplated that embodiments may be implemented using a single instance of computer system 1700, while in other embodiments multiple such systems, or multiple nodes making up computer system 1700, may be configured to host different portions or instances of embodiments. For example, in one embodiment some elements may be implemented via one or more nodes of computer system 1700 that are distinct from those nodes implementing other elements.

In various embodiments, computer system 1700 may be a uniprocessor system including one processor 1702, or a multiprocessor system including several processors 1702 (e.g., two, four, eight, or another suitable number). Processors 1702 may be any suitable processor capable of executing instructions. For example, in various embodiments processors 1702 may be general-purpose or embedded processors implementing any of a variety of instruction set architectures (ISAs), such as the x86, PowerPC, SPARC, or MIPS ISAs, or any other suitable ISA. In multiprocessor systems, each of processors 1702 may commonly, but not necessarily, implement the same ISA.

System memory 1704 may be configured to store program instructions 1720 accessible by processor 1702. In various embodiments, system memory 1704 may be implemented using any suitable memory technology, such as static random access memory (SRAM), synchronous dynamic RAM (SDRAM), nonvolatile/Flash-type memory, or any other type of memory. Additionally, existing camera control data 1722 of memory 1704 may include any of the information or data structures described above. In some embodiments, program instructions 1720 and/or data 1722 may be received, sent or stored upon different types of computer-accessible media or on similar media separate from system memory 1704 or computer system 1700. In various embodiments, some or all of the functionality described herein may be implemented via such a computer system 1700.

In one embodiment, I/O interface 1706 may be configured to coordinate I/O traffic between processor 1702, system memory 1704, and any peripheral devices in the device, including network interface 1710 or other peripheral interfaces, such as input/output devices 1712. In some embodiments, I/O interface 1706 may perform any necessary protocol, timing or other data transformations to convert data signals from one component (e.g., system memory 1704) into a format suitable for use by another component (e.g., processor 1702). In some embodiments, I/O interface 1706 may include support for devices attached through various types of peripheral buses, such as a variant of the Peripheral Component Interconnect (PCI) bus standard or the Universal Serial Bus (USB) standard, for example. In some embodiments, the function of I/O interface 1706 may be split into two or more separate components, such as a north bridge and a south bridge, for example. Also, in some embodiments some or all of the functionality of I/O interface 1706, such as an interface to system memory 1704, may be incorporated directly into processor 1702.

Network interface 1710 may be configured to allow data to be exchanged between computer system 1700 and other devices attached to a network 1724 (e.g., carrier or agent devices) or between nodes of computer system 1700. Network 1724 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1710 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1712 may, in some embodiments, include one or more display terminals, keyboards, keypads, touchpads, scanning devices, voice or optical recognition devices, or any other devices suitable for entering or accessing data by one or more computer systems 1700. Multiple input/output devices 1712 may be present in computer system 1700 or may be distributed on various nodes of computer system 1700. In some embodiments, similar input/output devices may be separate from computer system 1700 and may interact with one or more nodes of computer system 1700 through a wired or wireless connection, such as over network interface 1710.

Those skilled in the art will appreciate that computer system 1700 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1600 may be transmitted to computer system 1600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical assembly having one or more lenses;
an image sensor; and
a variable aperture assembly positioned along a light path extending from an object side of the one or more lenses of the optical assembly and to the image sensor, wherein the variable aperture assembly comprises:
a rotor,
a stator,
an actuator configured to rotate the rotor relative to the stator, and
a flexible membrane attached to both the rotor and the stator, wherein the flexible membrane is configured to vary a diameter of an aperture formed by the flexible membrane on the light path when the rotor rotates relative to the stator.

2. The camera of claim 1, wherein the actuator comprises a voice coil motor (VCM) actuator configured to cause the rotor to rotate relative to the stator and cause the flexible membrane to vary the diameter of the aperture, wherein the VCM actuator comprises a plurality of coils and a plurality of magnets, wherein the plurality of coils and the plurality of magnets are positioned radially around the light path and radially aligned along the light path.

3. The camera of claim 2, wherein some coils of the plurality of coils are of a first phase, and wherein remaining coils of the plurality of coils are of a second phase.

4. The camera of claim 2, wherein a first set of coils of the plurality of coils are of a first phase, wherein a second set of coils of the plurality of coils are of a second phase, and wherein a third set of coils of the plurality of coils are of a third phase.

5. The camera of claim 1, wherein the actuator comprises a voice coil motor (VCM) actuator configured to cause the rotor to rotate relative to the stator and cause the flexible membrane to vary the diameter of the aperture, wherein the VCM comprises a plurality of coils and a plurality of magnets, wherein the plurality of coils and the plurality of magnets are positioned radially around the light path, and wherein the plurality of coils and the plurality of magnets are located at different positions along the light path.

6. The camera of claim 5, wherein the plurality of coils comprises two coils, wherein each of the two coils comprise an undulating configuration that extends around the light path, and wherein the undulating configuration of a first coil of the two coils is off-set from the undulating configuration of a second coil of the two coils.

7. The camera of claim 6, further comprises a controller configured to modulate current flow through the two coils, wherein the controller is configured to alternate the supply of current between the first coil and the second coil at a frequency to cause the rotor to rotate relative to the stator and cause the flexible membrane to vary the diameter of the aperture.

8. The camera of claim 1, wherein the flexible membrane is configured to vary the diameter of the aperture between a fully open position and a fully closed position.

9. The camera of claim 1, wherein the flexible membrane is configured to vary the diameter of the aperture between a fully open position and one or more partially closed positions.

10. The camera of claim 1, wherein the flexible membrane is a single flexible membrane that is attached to both the rotor and the stator, and wherein the single flexible membrane is configured to vary the diameter of the aperture when the rotor rotates relative to the stator.

11. The camera of claim 1, wherein the flexible membrane is one of a plurality of flexible membranes respectively attached to both the rotor and the stator, and wherein the plurality of flexible membranes together vary the diameter of the aperture when the rotor rotates relative to the stator.

12. The camera of claim 11, wherein the respective flexible membranes of the plurality of flexible membranes comprises a strip-like shape.

13. A variable aperture assembly configured to be positioned along a light path that extends from an object side of one or more lenses of an optical assembly of a camera and to an image sensor of the camera, wherein the variable aperture assembly comprises:
a rotor;
a stator;
an actuator configured to rotate the rotor relative to the stator; and
a flexible membrane attached to both the rotor and the stator, wherein the flexible membrane is configured to vary a diameter of an aperture formed by the flexible membrane on the light path when the rotor rotates relative to the stator.

14. The variable aperture assembly of claim 13, wherein the actuator comprises a voice coil motor (VCM) actuator configured to cause the rotor to rotate relative to the stator and cause the flexible membrane to vary the diameter of the aperture, wherein the VCM actuator comprises a plurality of coils and a plurality of magnets, wherein the plurality of coils and the plurality of magnets are positioned radially around the light path and radially aligned along the light path.

15. The variable aperture assembly of claim 13, wherein the flexible membrane is configured to vary the diameter of the aperture between a fully open position and a fully closed position.

16. The variable aperture assembly of claim 13, wherein the flexible membrane is configured to vary the diameter of the aperture between a fully open position and one or more partially closed positions.

17. The variable aperture assembly of claim 13, wherein the flexible membrane is a single flexible membrane that is attached to both the rotor and the stator, and wherein the single flexible membrane is configured to vary the diameter of the aperture when the rotor rotates relative to the stator.

18. The variable aperture assembly of claim 13, wherein the flexible membrane is one of a plurality of flexible membranes respectively attached to both the rotor and the stator, and wherein the plurality of flexible membranes together vary the diameter of the aperture when the rotor rotates relative to the stator.

19. The variable aperture assembly of claim 18, wherein the respective flexible membranes of the plurality of flexible membranes comprises a strip-like shape.

20. A device, comprising:
a display;
a camera;
one or more processors; and
memory storing program instructions executable by the one or more processors to cause images captured by the camera to be displayed on the display; and
the camera comprising:
an optical assembly having one or more lenses;
an image sensor; and
a variable aperture assembly positioned along a light path extending from an object side of the one or more lenses of the optical assembly and to the image sensor, wherein the variable aperture assembly comprises:
a rotor,
a stator,
an actuator configured to rotate the rotor relative to the stator, and
a flexible membrane attached to both the rotor and the stator, wherein the flexible membrane is configured to vary a diameter of an aperture formed by the flexible membrane on the light path when the rotor rotates relative to the stator.
